(19) United States
(12) Patent Application Publication
(10) Pub. No.: US 2018/0211373 A1
(43) Pub. Date: Jul. 26, 2018

(54) SYSTEMS AND METHODS FOR DEFECT DETECTION

(71) Applicant: AQUIFI, INC., Palo Alto, CA (US)

(72) Inventors: Michele Stoppa, Sunnyvale, CA (US); Francesco Peruch, Sunnyvale, CA (US); Giuliano Pasqualotto, Mountain View, CA (US); Aryan Hazeghi, Palo Alto, CA (US); Pietro Salvagnini, Sunnyvale, CA (US); Carlo Dal Mutto, Sunnyvale, CA (US); Jason Trachewsky, Menlo Park, CA (US); Kinh Tieu, Sunnyvale, CA (US)

(21) Appl. No.: 15/866,217

(22) Filed: Jan. 9, 2018

Related U.S. Application Data
(60) Provisional application No. 62/448,952, filed on Jan. 20, 2017.

(51) Int. Cl. G06T 7/00; G06T 17/20; G06K 9/00

(52) U.S. Cl. CPC G06T 7/001; G06K 9/00214; G06T 17/20

(57) ABSTRACT

A method for detecting a defect in an object includes: capturing, by one or more depth cameras, a plurality of partial point clouds of the object from a plurality of different poses with respect to the object; merging, by a processor, the partial point clouds to generate a merged point cloud; computing, by the processor, a three-dimensional (3D) multi-view model of the object; detecting, by the processor, one or more defects of the object in the 3D multi-view model; and outputting, by the processor, an indication of the one or more defects of the object.

### CROSS-REFERENCE TO RELATED APPLICATION(S)

This application claims the benefit of U.S. Provisional Patent Application No. 62/448,952, filed in the United States Patent and Trademark Office on Jan. 20, 2017, the entire disclosure of which is incorporated by reference herein.

### FIELD

Aspects of embodiments of the present invention relate to the field of three-dimensional (3D) scanning, in particular, systems and methods for generating three-dimensional models of objects using scanning devices.

### BACKGROUND

The problem of detecting anomalous or defective objects among a collection of different objects is common in a variety of contexts. For example, a quality assurance system may improve the quality of goods that are delivered to customers by detecting defective goods and delivering only non-defective goods to customers.

As a specific example, when manufacturing shoes, it may be beneficial to inspect the shoes to ensure that the stitching is secure, to ensure that the sole is properly attached, and to ensure that the eyelets are correctly formed. This inspection is typically performed manually by a human inspector. The human inspector may manually evaluate the shoes and remove shoes that have defects. In some instances, where the goods are low cost such as when manufacturing containers (e.g., jars), it may be beneficial to inspect the containers to ensure that they are not cracked or punctured, and to ensure that various parts (e.g., screw threads of the jar) are formed properly, but it may not be cost effective for a human inspector to manually evaluate the containers.

Defect detection systems may also be used in other contexts, such ensuring that the customized goods are consistent with the specifications provided by a customer (e.g., that the color and size of a customized piece of clothing are consistent with what was ordered by the customer).

### SUMMARY

Aspects of embodiments of the present invention are directed to systems and methods for defect detection in physical objects. Some aspects of embodiments of the present invention relate to the automatic capture of three-dimensional (3D) models of physical objects and the automatic detection of defects in the physical objects based on the captured 3D model of the object. Some aspects of the invention relate to comparing the captured 3D model to a reference model, and some aspects relate to supplying the captured 3D model to a classifier model, such as a multi-class neural network, where the classes correspond to confidences of the detection of various types of defects.

According to one embodiment of the present invention, a method for detecting a defect in an object includes: capturing, by one or more depth cameras, a plurality of partial point clouds of the object from a plurality of different poses with respect to the object; merging, by a processor, the partial point clouds to generate a merged point cloud; computing, by the processor, a three-dimensional (3D) multi-view model of the object; detecting, by the processor, one or more defects of the object in the 3D multi-view model; and outputting, by the processor, an indication of the one or more defects of the object.

The detecting the one or more defects may include: aligning the 3D multi-view model with a reference model; comparing the 3D multi-view model to the reference model to compute a plurality of differences between corresponding regions of the 3D multi-view model and the reference model; and detecting the one or more defects in the object when one or more of the plurality of differences exceeds a threshold.

The comparing the 3D multi-view model to the reference model may include: dividing the 3D multi-view model into a plurality of regions; identifying corresponding regions of the reference model; detecting locations of features in the regions of the 3D multi-view model; computing distances between detected features in the regions of the 3D multi-view model and locations of features in the corresponding regions of the reference model; and outputting the distances as the plurality of differences.

The method may further include: computing a plurality of features based on the 3D multi-view model, the features including color, texture, and shape; and assigning a classification to the object in accordance with the plurality of features, the classification including one of: one or more classifications, each classification corresponding to a different type of defect; and a clean classification.

The computing the plurality of features may include: rendering one or more two-dimensional views of the 3D multi-view model; and computing the plurality of features based on the one or more two-dimensional views of the object.

The computing the plurality of features may include: dividing the 3D multi-view model into a plurality of regions; and computing the plurality of features based on the plurality of regions of the 3D multi-view model.

The assigning the classification to the object in accordance with the plurality of features may be performed by a convolutional neural network, and the convolutional neural network may be trained by: receiving a plurality of training 3D models of objects and corresponding training classifications; computing a plurality of feature vectors from the training 3D models by the convolutional neural network; computing parameters of the convolutional neural network; computing a training error metric between the training classifications of the training 3D models with outputs of the convolutional neural network configured based on the parameters; computing a validation error metric in accordance with a plurality of validation 3D models separate from the training 3D models; in response to determining that the training error metric and the validation error metric fail to satisfy a threshold, generating additional 3D models with different defects to generate additional training data; in response to determining that the training error metric and the validation error metric satisfy the threshold, configuring the neural network in accordance with the parameters; receiving a plurality of test 3D models of objects with unknown classifications; and classifying the test 3D models using the configured convolutional neural network.

The assigning the classification to the object in accordance with the plurality of features may be performed by: comparing each of the features to a corresponding previously observed distribution of values of the feature; assigning the clean classification in response to determining that all of the values of the features are within a typical range; and assigning a defect classification for each feature of the plurality of features that are in outlier portions of the corresponding previously observed distribution.

The method may further include displaying the indication of the one or more defects on a display device.

The display device may be configured to display the 3D multi-view model, and the one or more defects may be displayed as a heat map overlaid on the 3D multi-view model.

The indication of the one or more defects of the object may control movement of the object out of a normal processing route.

The object may be located on a conveyor system, and the one or more depth cameras may be arranged around the conveyor system to image the object as the object moves along the conveyor system.

The point clouds may be captured at different times as the object moves along conveyor system.

The 3D multi-view model may include a 3D mesh model.

The 3D multi-view model may include a 3D point cloud.

The 3D multi-view model may include a plurality of two-dimensional images.

According to one embodiment of the present invention, a system for detecting a defect in an object includes: a plurality of depth cameras arranged to have a plurality of different poses with respect to the object; a processor in communication with the depth cameras; and a memory storing instructions that, when executed by the processor, cause the processor to. receive, from the one or more depth cameras, a plurality of partial point clouds of the object from the plurality of different poses with respect to the object; merge the partial point clouds to generate a merged point cloud; compute a three-dimensional (3D) multi-view model of the object; detect one or more defects of the object in the 3D multi-view model; and output an indication of the one or more defects of the object.

The memory may further store instructions that, when executed by the processor, cause the processor to detect the one or more defects by: aligning the 3D multi-view model with a reference model; comparing the 3D multi-view model to the reference model to compute a plurality of differences between corresponding regions of the 3D multi-view model and the reference model; and detecting the one or more defects in the object when one or more of the plurality of differences exceeds a threshold.

The memory may further store instructions that, when executed by the processor, cause the processor to compare the 3D multi-view model to the reference model by: dividing the 3D multi-view model into a plurality of regions; identifying corresponding regions of the reference model; detecting locations of features in the regions of the 3D multi-view model; computing distances between detected features in the regions of the 3D multi-view model and locations of features in the corresponding regions of the reference model; and outputting the distances as the plurality of differences.

The memory may further store instructions that, when executed by the processor, cause the processor to: compute a plurality of features based on the 3D multi-view model, the features including color, texture, and shape; and assign a classification to the object in accordance with the plurality of features, the classification including one of: one or more classifications, each classification corresponding to a different type of defect; and a clean classification.

The memory may further store instructions that, when executed by the processor, cause the processor to: render one or more two-dimensional views of the 3D multi-view model; and compute the plurality of features based on the one or more two-dimensional views of the object.

The memory may further store instructions that, when executed by the processor, cause the processor to compute the plurality of features by: dividing the 3D multi-view model into a plurality of regions; and computing the plurality of features based on the plurality of regions of the 3D multi-view model.

The memory may further store instructions that, when executed by the processor, cause the processor to assign the classification to the object using a convolutional neural network, and wherein the convolutional neural network is trained by: receiving a plurality of training 3D models of objects and corresponding training classifications; computing a plurality of feature vectors from the training 3D models by the convolutional neural network; computing parameters of the convolutional neural network; computing a training error metric between the training classifications of the training 3D models with outputs of the convolutional neural network configured based on the parameters; computing a validation error metric in accordance with a plurality of validation 3D models separate from the training 3D models; in response to determining that the training error metric and the validation error metric fail to satisfy a threshold, generating additional 3D models with different defects to generate additional training data; in response to determining that the training error metric and the validation error metric satisfy the threshold, configuring the neural network in accordance with the parameters; receiving a plurality of test 3D models of objects with unknown classifications; and classifying the test 3D models using the configured convolutional neural network.

The memory may further store instructions that, when executed by the processor, cause the processor to assign the classification to the object in accordance with the plurality of features by: comparing each of the features to a corresponding previously observed distribution of values of the feature; assigning the clean classification in response to determining that all of the values of the features are within a typical range; and assigning a defect classification for each feature of the plurality of features that are in outlier portions of the corresponding previously observed distribution.

The system may further include a display device, and the memory may further store instructions that, when executed by the processor, cause the processor to display the indication of the one or more defects on the display device.

The memory may further store instructions that, when executed by the processor, cause the processor to: display, on the display device, the indication of the one or more defects as a heat map overlaid on the 3D multi-view model.

The memory may further store instructions that, when executed by the processor, cause the processor to control the movement of the object out of a normal processing route based on the indication of the one or more defects.

The system may further include a conveyor system, wherein the object is moving on the conveyor system, and the one or more depth cameras may be arranged around the conveyor system to image the object as the object moves along the conveyor system.

The point clouds may be captured at different times as the object moves along the conveyor system.

The 3D multi-view model may include a 3D mesh model.

The 3D multi-view model may include a 3D point cloud.

The 3D multi-view model may include a plurality of two-dimensional images.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1A is a schematic depiction of an object (depicted as a handbag) traveling on a conveyor belt with a plurality of (five) cameras concurrently imaging the object according to one embodiment of the present invention.

FIG. 1B is a schematic depiction of an object (depicted as a handbag) traveling on a conveyor belt having two portions, where the first portion moves the object along a first direction and the second portion moves the object along a second direction that is orthogonal to the first direction in accordance with one embodiment of the present invention.

FIG. 2 is a schematic block diagram of a depth camera according to one embodiment of the present invention.

FIG. 3A is a schematic block diagram illustrating a system for defect detection according to one embodiment of the present invention.

FIG. 3B is a flowchart of a method for detecting defects according to one embodiment of the present invention.

FIGS. 4A and 4B respectively depict a single depth camera imaging a surface and two lower resolution depth cameras imaging the same surface, according to some embodiments of the present invention.

FIG. 4C depicts a single depth camera with two projectors according to one embodiment of the present invention.

FIG. 4D depicts a single depth camera with four projectors according to one embodiment of the present invention.

FIG. 4E depicts three depth cameras at different distances from a surface to image the surface at different resolutions according to one embodiment of the present invention.

FIGS. 5A and 5B show multiple depth cameras with illuminators illuminating a surface with a curve according to one embodiment of the present invention.

FIG. 6 illustrates a structure of a system with three cameras having overlapping fields of view and having projectors configured to emit patterns in overlapping portions of the scene according to one embodiment of the present invention.

FIGS. 7A, 7B, and 7C illustrate the quality of the depth images generated by the embodiment shown in FIG. 6 with different combinations of projectors being turned on according to one embodiment of the present invention.

FIG. 8 is a flowchart of a method for performing defect detection according to one embodiment of the present invention.

FIG. 9 is a schematic representation of a convolutional neural network that may be used in accordance with embodiments of the present invention.

FIG. 10 illustrates a portion of a user interface displaying defects in a scanned object according to one embodiment of the present invention, in particular, three views of a shoe, where the color indicates the magnitude of the defects.

FIG. 11A is a schematic depiction of depth cameras imaging stitching along a clean seam and FIG. 11B is a schematic depiction of a user interface visualizing the imaged clean seam according to one embodiment of the present invention.

FIG. 12A is a schematic depiction of depth cameras imaging stitching along a defective seam and FIG. 12B is a schematic depiction of a user interface visualizing the imaged defective seam according to one embodiment of the present invention.

FIG. 13A is a photograph of a handbag having a tear in its base and FIG. 13B is a heat map generated by a defected detection system according to one embodiment of the present invention, where the heat map is overlaid on the 3D model of the object and portions of the heat map rendered in red correspond to areas containing a defect and areas rendered in blue correspond to areas that are clean.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

As noted above, aspects of embodiments of the present invention are directed to systems and methods for defect detection in physical objects. One application for such systems and methods is in the context of manufacturing, where embodiments of the present invention automatically (e.g., without human involvement) perform three-dimensional (3D) scans of goods produced in the manufacturing process to generate a 3D model of the object, and by automatically analyzing the 3D model (e.g., again, without human involvement) to detect one or more defects in the scanned object (e.g., the object produced by the manufacturing process) or to detect that the object is within the acceptable range of tolerances. Some aspects of the invention relate to comparing the captured 3D model to a reference model, and some aspects relate to supplying the captured 3D model to a classifier model, such as a multi-class neural network, where the classes correspond to confidences of the detection of various types of defects. In some embodiments, the output of the defect detection process may be displayed to a human operator, such as on a display device. In some embodiments, the defect detection is used to control a system for removing the defective object from the stream of products, such that the defective object is not delivered to customers.

Embodiments of the present invention may also be used to classify or sort different objects in a system. For example, products moving along a conveyor system (e.g., conveyor belt, overhead I-beam conveyor, pneumatic conveyors, gravity conveyors, chain conveyors, and the like) in a factory may be one of a number of different types (e.g., different models of shoes or different types of fruit), and embodiments of the present invention may be used to classify the object as one of the different types and to sort or divert the object (e.g., by controlling conveyor belts or other mechanical parts of the factory) by directing the object in a direction corresponding to the selected type (e.g., along a different output path or divert an object from a normal processing route).

In general, a single camera is unable to acquire the full 3D shape of the object from a single position relative to the object, because, at any given time, some surfaces of the object will typically be occluded. As such, in order to generate a three-dimensional model of an object, embodiments of the present invention capture data regarding the object from multiple directions (e.g., multiple “poses” relative to the object) in order to capture substantially all externally visible surfaces of the object. In many instances, the object may be resting on one of its surfaces, and that surface may be occluded or hidden from by the structure that the object is resting on (e.g., in the case of a shoe that is upright on a conveyor belt, the sole of the shoe may be occluded or obscured by the conveyor belt itself). In some contexts, the term “mapping” is also used to refer to the process of capturing a 3D model of a physical space or object.

Some aspects of embodiments of the present invention relate to a 3D scanning system that includes one or more range cameras or depth cameras. Each depth camera is configured to capture data for generating a 3D reconstruction of the portion of the object within its field of view (FOV, referring to the solid angle imaged by the camera) and the depth cameras can capture different views of the object (e.g., views of different sides of the object). This 3D reconstruction may be a point cloud, which includes a plurality of points, each point having three dimensional coordinates (e.g., x, y, and z coordinates or spherical coordinates in the form of a polar angle, an azimuth angle, and a radial distance, with the camera at the origin). The partial data from different poses can then be aligned and combined to create 3D model of the shape and, if available, color (e.g., texture information) of the object as captured by a color (e.g., red, green, and blue or “RGB”) camera. While this operation could be performed by moving a single camera around the object, this would generally require moving the camera around the object and/or moving (e.g., rotating) the object within the field of view of the camera, and this operation may be slow, which might not be practical due to the time constraints imposed by high throughput environments.

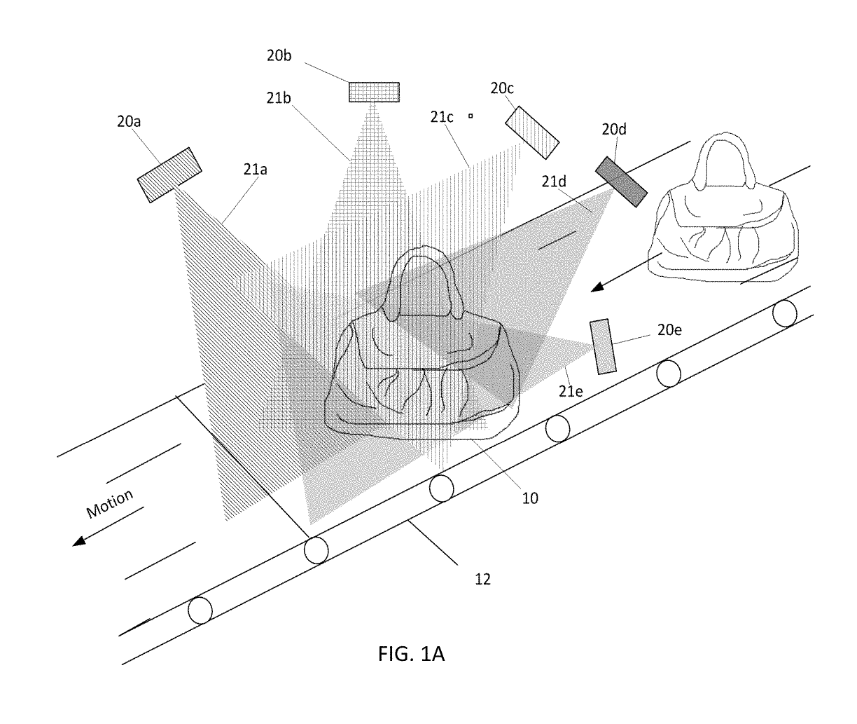

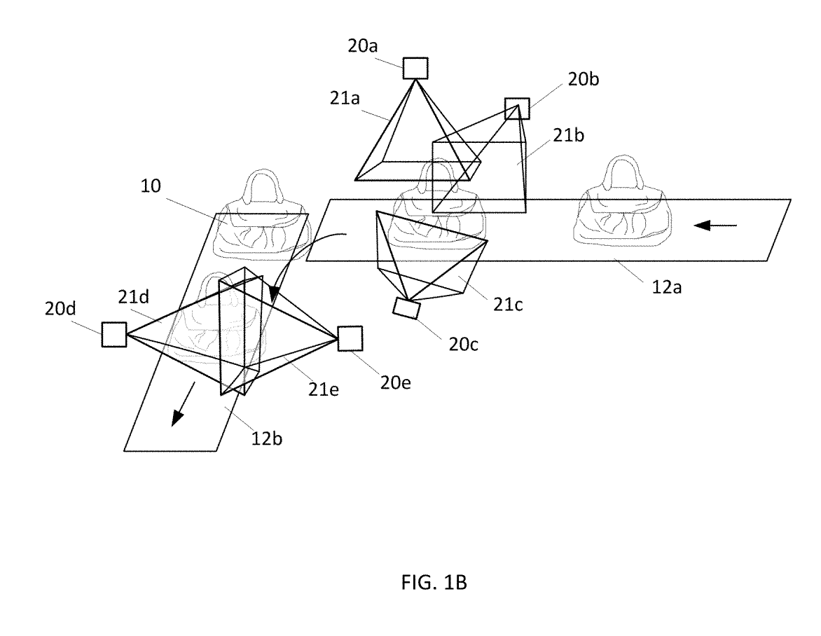

In contrast, by concurrently or substantially simultaneously capturing multiple views of the object using multiple depth cameras, all of the data needed to generate a dense (e.g., high resolution) 3D model can be captured much more quickly (e.g., substantially instantaneously), without the need for mechanisms to move a camera around the object. In addition, if the object is on a conveyer belt (see, e.g., FIG. 1, as described in more detail below), the same camera can continuously scan the object from one view point as the object slides in front of the camera, while the other cameras scan the same object from other viewpoints. By the time the object has completely moved out of the sight of the cameras, the object is practically fully scanned (e.g., all visible surfaces of the object are scanned).

Furthermore, the individual bandwidths of the cameras can be aggregated to result in a much higher aggregate bandwidth (as compared to a single camera) for transferring sensor data to off-line processing nodes such as servers and the cloud (e.g., one or more servers on the Internet).

For small and very simple objects, a small number of range images produced by a few depth cameras at different locations and orientations may be enough to capture the object's full shape. For larger, more complex objects with non-convex shapes, more depth cameras may be needed to capture additional views to capture all of the visible surfaces of the object, as discussed in more detail below.

Another consideration is the resolution at which various surface elements or patches of the object are captured. While, in some cases, uniform resolution is desirable, other situations may call for variable resolution, with some parts of the object captured at higher resolution than others (e.g., a more complex portion of an object may benefit from higher resolution capture, while smoother portions of the object may not require the additional resolution). For the sake of clarity, in the following discussion, the term “pixel resolution” refers to the number of pixels available at a camera's focal plane, and the term “geometric resolution” refers to the number of pixels in the camera's focal plane that see a unit surface area. While pixel resolution is a characteristic of the camera, geometric resolution also depends on the location and orientation of the camera with respect to the surface.

Similarly, in various embodiments of the present invention, cameras with different characteristics can be used depending on the geometric (e.g., shape) details or texture materials (e.g., patterns), and color of the object. For instance, the object being scanned may be a hand bag having leather on the sides, fabric at the top, and some mixed material (including metallic surfaces) in the handle structure. The characteristics or tuning of each depth camera may be configured in accordance with the characteristics or features of interest of the portion of the object that is expected to be imaged by the corresponding depth camera. For example, low resolution may suffice for regions that do not have much detail (e.g., the sides of a handbag), while other portions with high detail may require higher resolution (e.g., a detailed logo on the side of a handbag, or fine stitching). Some regions may require more depth resolution to detect features (e.g., the detailed shape of a part of the object) while other regions may require more detailed color or texture information, thereby requiring higher resolution depth cameras or color cameras to image those regions, respectively.

The cameras can also be arranged to have overlapping fields of view. Assuming that n cameras capture overlapping images of a portion of an object and assuming a normal distribution of the depth error measurement by each camera, the standard deviation (and thus the depth error) of the aggregated measurement in the corresponding portion of the model is reduced by SQRT(n), which is a significant reduction in errors when computing 3D models of objects.

FIG. 1A is a schematic depiction of an object 10 (depicted as a handbag) traveling on a conveyor belt 12 with a plurality of (five) cameras 20 (labeled 20a, 20b, 20c, 20d, and 20e) concurrently imaging the object according to one embodiment of the present invention. The fields of view 21 of the cameras (labeled 21a, 21b, 21c, 21d, and 21e) are depicted as triangles with different shadings, and illustrate the different views (e.g., surfaces) of the object that are captured by the cameras 20. The cameras 20 may include both color and infrared (IR) imaging units to capture both geometric and texture properties of the object. The cameras 20 may be arranged around the conveyor belt 12 such that they do not obstruct the movement of the object 10 as the object moves along the conveyer belt 12.

The cameras may be stationary and configured to capture images when at least a portion of the object 10 enters their respective fields of view (FOVs) 21. The cameras 20 may be arranged such that the combined FOVs 21 of cameras cover all critical (e.g., visible) surfaces of the object 10 as it moves along the conveyor belt 12 and at a resolution appropriate for the purpose of the captured 3D model (e.g., with more detail around the stitching that attaches the handle to the bag).

As one example of an arrangement of cameras, FIG. 1B is a schematic depiction of an object 10 (depicted as a handbag) traveling on a conveyor belt 12 having two portions, where the first portion moves the object 10 along a first direction and the second portion moves the object 10 along a second direction that is orthogonal to the first direction in accordance with one embodiment of the present invention. When the object 10 travels along the first portion 12a of the conveyor belt 12, a first camera 20a images the top surface of the object 10 from above, while second and third cameras 20b and 20c image the sides of the object 10. In this arrangement, it may be difficult to image the ends of the object 10 because doing so would require placing the cameras along the direction of movement of the conveyor belt and therefore may obstruct the movement of the objects 10. As such, the object 10 may transition to the second portion 12b of the conveyor belt 12, where, after the transition, the end of the object 10 are now visible to cameras 20d and 20e located on the sides of the second portion 12b of the conveyor belt 12. As such, FIG. 1B illustrates an example of an arrangement of cameras that allows coverage of the entire visible surface of the object 10.

In circumstances where the cameras are stationary (e.g., have fixed locations), the relative poses of the cameras 20 can be estimated a priori, thereby improving the pose estimation of the cameras, and the more accurate pose estimation of the cameras improves the result of 3D reconstruction algorithms that merge the separate partial point clouds generated from the separate depth cameras.

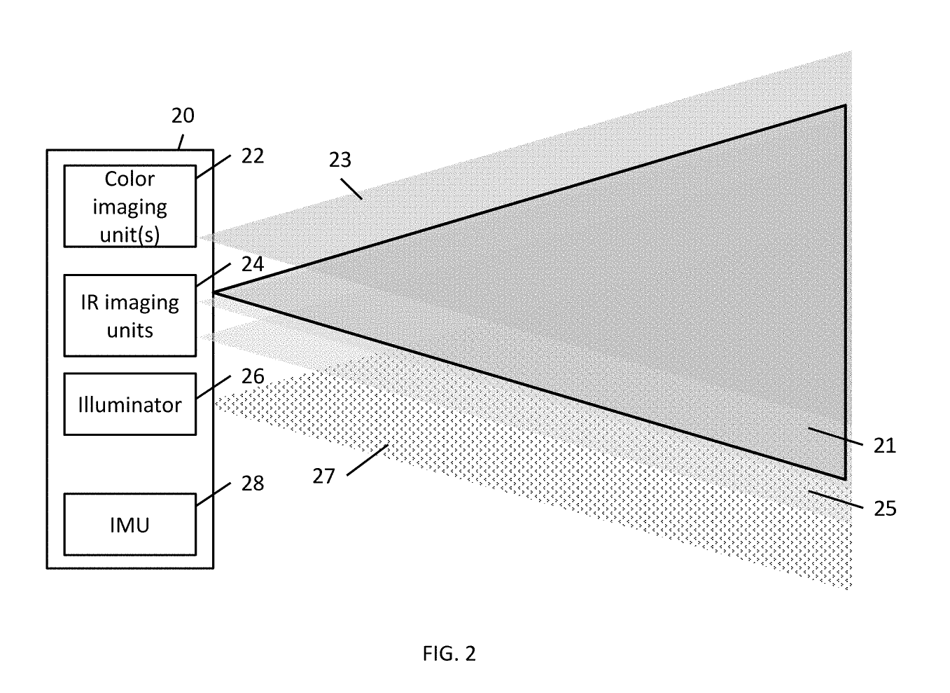

FIG. 2 is a schematic block diagram of a depth camera 20 according to one embodiment of the present invention. According to some embodiments of the present invention, each of the cameras 20 of the system includes color and IR imaging units 22 and 24, illuminators 26 (e.g., projection sources), and Inertial Measurement Units (IMU) 28. The imaging units 22 and 24 may be standard two dimensional cameras, where each imaging unit includes an image sensor (e.g., a complementary metal oxide semiconductor or CMOS sensor), and an optical system (e.g., one or more lenses) to focus light onto the image sensor. These sensing components acquire the data for generating the 3D models of the objects and to estimate the relative pose of the camera 20 with respect to the object 10 being acquired during the acquisition itself. In some embodiments, these sensing components are synchronized with each other (e.g., controlled to operate substantially simultaneously, such as within nanoseconds). In one embodiment of the acquisition system, the sensing components include one or more IMUs 28, one or more color cameras 22, one or more Infra-Red (IR) cameras 24, and one or more IR illuminators or projectors 26. The imaging units 22 and 24 have overlapping fields of view 23 and 25 (shown in FIG. 2 as gray triangles) and optical axes that are substantially parallel to one another, and the illuminator 26 is configured to project light 27 (shown in FIG. 2 as a gray triangle) in a pattern into the fields of view of the imaging units 22 (shown in FIG. 2 as a triangle with solid lines) and 24. The combined camera system 20, as such, has a combined field of view 21 in accordance with the overlapping fields of view of the imaging units 22 and 24.

The illuminator 26 may be used to generate a “texture” that is visible to one or more regular cameras. This texture is usually created by a diffractive optical element (see, e.g., Swanson, Gary J., and Wilfrid B. Veldkamp. “Diffractive optical elements for use in infrared systems.” Optical Engineering 28.6 (1989): 286605-286605. [0075]), placed in front of a laser projector. (See, e.g., U.S. Pat. No. 9,325,973 “Dynamically Reconfigurable Optical Pattern Generator Module Useable With a System to Rapidly Reconstruct Three-Dimensional Data” issued on Apr. 26, 2016; U.S. Pat. No. 9,778,476 “3D Depth Sensor and Projection System and Methods of Operating Thereof,” filed in the United States Patent and Trademark Office on Jun. 18, 2015, issued on Oct. 3, 2017; and U.S. patent application Ser. No. 15/381,938 “System and Method for Speckle Reduction in Laser Projectors,” filed in the United States Patent and Trademark Office on Dec. 16, 2016 the entire disclosures of which are incorporated by reference herein.) If only one camera is used, then depth is reconstructed based on identification of each specific sub-pattern in the texture. Due to parallax, the location of this sub-pattern in the image changes with the distance of the surface element that reflects it. Knowledge of the camera-projector geometry (estimated by prior calibration) allows one to reconstruct the depth of this surface element from the sub-pattern image location (see, e.g., Smisek, J., Jancosek, M., & Pajdla, T. (2013). 3D with Kinect. In Consumer Depth Cameras for Computer Vision (pp. 3-25). Springer London.). Such a method is typically referred to as structured light method. In other cases, two cameras are used in a standard stereo configuration (see, e.g., Konolige, K. Projected texture stereo. In Robotics and Automation (ICRA), 2010 IEEE International Conference on (pp. 148-155). (May 2010) IEEE.). The projected pattern assists in optimizing depth estimation via disparity computation along conjugate epipolar lines. While the embodiments of the present invention will be described in the context of this latter configuration for the purpose of this application, although similar considerations apply to structure light or any other type of range image sensor. Generally, the projector is located in close vicinity to the cameras, in order to ensure that the projector covers the area imaged by the two cameras.

One example of an acquisition system is described in U.S. patent application Ser. No. 15/147,879 “Depth Perceptive Trinocular Camera System,” filed in the United States Patent and Trademark Office on May 5, 2016, issued on Jun. 6, 2017 as U.S. Pat. No. 9,674,504, the entire disclosure of which is incorporated by reference. In some embodiments, rather than using at least two infrared cameras and at least one color camera, at least two RGB-IR cameras are used instead, where the RGB-IR cameras are capable of capturing both visible light (red, green, and blue channels) and infrared light (an IR channel) (see, e.g., U.S. Pat. No. 9,392,262 “System and Method for 3D Reconstruction Using Multiple Multi-Channel Cameras,” issued on Jul. 12, 2016, the entire disclosure of which is incorporated herein by reference).

The illuminator (or illuminators) 26 may include a laser diode, and may also include a diffractive optical element for generating a pattern and systems for reducing laser speckle, as described in, for example: U.S. patent application Ser. No. 14/743,742 “3D Depth Sensor and Projection System and Methods of Operating Thereof,” filed in the United States Patent and Trademark Office on Jun. 18, 2015, issued on Oct. 3, 2017 as U.S. Pat. No. 9,778,476; U.S. patent application Ser. No. 15/381,938 “System and Method for Speckle Reduction in Laser Projectors,” filed in the United States Patent and Trademark Office on Dec. 16, 2016; and U.S. patent application Ser. No. 15/480,159 “Thin Laser Package for Optical Applications,” filed in the United States Patent and Trademark Office on Apr. 5, 2017, the entire disclosures of which are incorporated by reference herein.

In the following discussion, the image acquisition system of the depth camera system may be referred to as having at least two cameras, which may be referred to as a “master” camera and one or more “slave” cameras. Generally speaking, the estimated depth or disparity maps computed from the point of view of the master camera, but any of the cameras may be used as the master camera. As used herein, terms such as master/slave, left/right, above/below, first/second, and CAM1/CAM2 are used interchangeably unless noted. In other words, any one of the cameras may be master or a slave camera, and considerations for a camera on a left side with respect to a camera on its right may also apply, by symmetry, in the other direction. In addition, while the considerations presented below may be valid for various numbers of cameras, for the sake of convenience, they will generally be described in the context of a system that includes two cameras. For example, a depth camera system may include three cameras. In such systems, two of the cameras may be invisible light (infrared) cameras and the third camera may be a visible light (e.g., a red/blue/green color camera) camera. All three cameras may be optically registered (e.g., calibrated) with respect to one another.

To detect the depth of a feature in a scene imaged by a camera 20, the system determines the pixel location of the feature in each of the images captured by the cameras. The distance between the features in the two images is referred to as the disparity, which is inversely related to the distance or depth of the object. (This is the effect when comparing how much an object “shifts” when viewing the object with one eye at a time—the size of the shift depends on how far the object is from the viewer's eyes, where closer objects make a larger shift and farther objects make a smaller shift and objects in the distance may have little to no detectable shift.) Techniques for computing depth using disparity are described, for example, in R. Szeliski. “Computer Vision: Algorithms and Applications”, Springer, 2010 pp. 467 et seq. As such, a depth map can be calculated from the disparity map (e.g., as being proportional to the inverse of the disparity values).

The magnitude of the disparity between the master and slave cameras depends on physical characteristics of the depth camera system, such as the pixel resolution of cameras, distance between the cameras and the fields of view of the cameras. Therefore, to generate accurate depth measurements, the depth camera system (or depth perceptive depth camera system) is calibrated based on these physical characteristics in order to adjust the values computed from the disparity map to generate values corresponding to real-world lengths (e.g., depth distances between the camera and the features in the images). The resulting collection of three dimensional points correspond to a point cloud of the scene, including a first dimension corresponding to a “horizontal” and “vertical” directions along the plane of the image sensors (which may correspond to polar and azimuthal angles) and a distance from the camera 20 (which corresponds to a radial coordinate). As such, the depth camera 20 collects data that can be used to generate a point cloud.

In some depth camera systems, the cameras may be arranged such that horizontal rows of the pixels of the image sensors of the cameras are substantially parallel. Image rectification techniques can be used to accommodate distortions to the images due to the shapes of the lenses of the cameras and variations of the orientations of the cameras.

In more detail, camera calibration information can provide information to rectify input images so that epipolar lines of the equivalent camera system are aligned with the scanlines of the rectified image. In such a case, a 3D point in the scene projects onto the same scanline index in the master and in the slave image. Let uₘ and uₛ be the coordinates on the scanline of the image of the same 3D point p in the master and slave equivalent cameras, respectively, where in each camera these coordinates refer to an axis system centered at the principal point (the intersection of the optical axis with the focal plane) and with horizontal axis parallel to the scanlines of the rectified image. The difference uₛ−uₘ is called disparity and denoted by d; it is inversely proportional to the orthogonal distance of the 3D point with respect to the rectified cameras (that is, the length of the orthogonal projection of the point onto the optical axis of either camera).

Stereoscopic algorithms exploit this property of the disparity. These algorithms achieve 3D reconstruction by matching points (or features) detected in the left and right views, which is equivalent to estimating disparities. Block matching (BM) is a commonly used stereoscopic algorithm. Given a pixel in the master camera image, the algorithm computes the costs to match this pixel to any other pixel in the slave camera image. This cost function is defined as the dissimilarity between the image content within a small window surrounding the pixel in the master image and the pixel in the slave image. The optimal disparity at point is finally estimated as the argument of the minimum matching cost. This procedure is commonly addressed as Winner-Takes-All (WTA). These techniques are described in more detail, for example, in R. Szeliski. “Computer Vision: Algorithms and Applications”, Springer, 2010. Since stereo algorithms like BM rely on appearance similarity, disparity computation becomes challenging if more than one pixel in the slave image have the same local appearance, as all of these pixels may be similar to the same pixel in the master image, resulting in ambiguous disparity estimation. A typical situation in which this may occur is when visualizing a scene with constant brightness, such as a flat wall.

Methods exist that provide additional illumination by projecting a pattern that is designed to improve or optimize the performance of block matching algorithm that can capture small 3D details such as the one described in U.S. Pat. No. 9,392,262 “System and Method for 3D Reconstruction Using Multiple Multi-Channel Cameras,” issued on Jul. 12, 2016, the entire disclosure of which is incorporated herein by reference. Another approach projects a pattern that is purely used to provide a texture to the scene and particularly improve the depth estimation of texture-less regions by disambiguating portions of the scene that would otherwise appear the same. These patterns may be projected by the illuminators 26 of the cameras 20.

Each depth camera may be operating in synchrony with their respective IR pattern projector (or a modulated light for Time-of-flight style depth cameras). The pattern emitted by an IR pattern projector 26a associated with one camera 20a may overlap with the pattern emitted by an IR pattern projector 26b of a second camera 20b, enabling the production of a better quality depth measurement by the first or the second camera, compared to if each camera was operating by its own pattern projector. See, e.g., patent application Ser. No. 15/147,879 “Depth Perceptive Trinocular Camera System,” filed in the United States Patent and Trademark Office on May 5, 2016, issued on Jun. 6, 2017 as U.S. Pat. No. 9,674,504, the entire disclosure of which is incorporated by reference. In addition, embodiments of the present invention where the IR pattern projectors are separate from the cameras 20 will be discussed in more detail below.

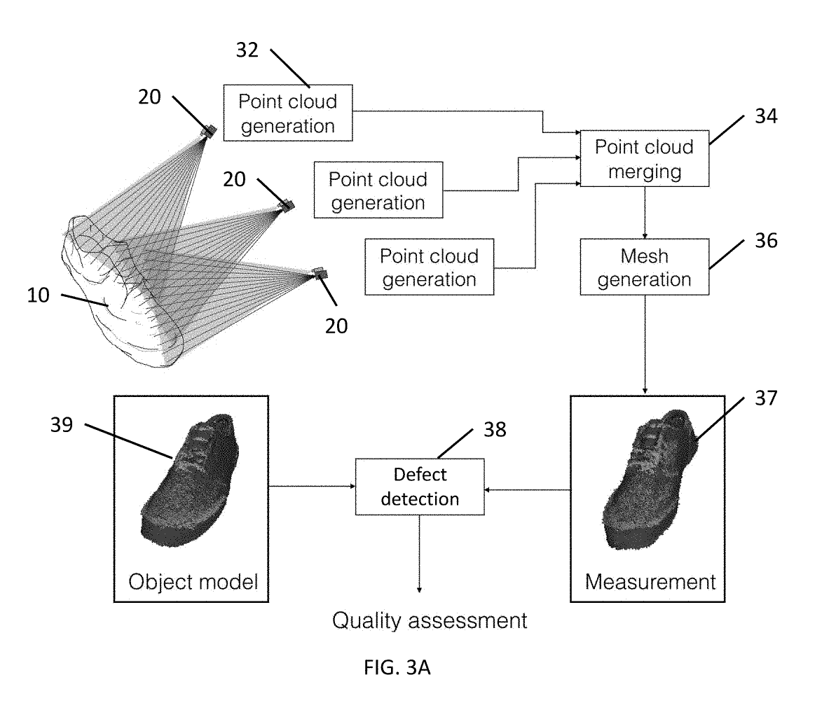

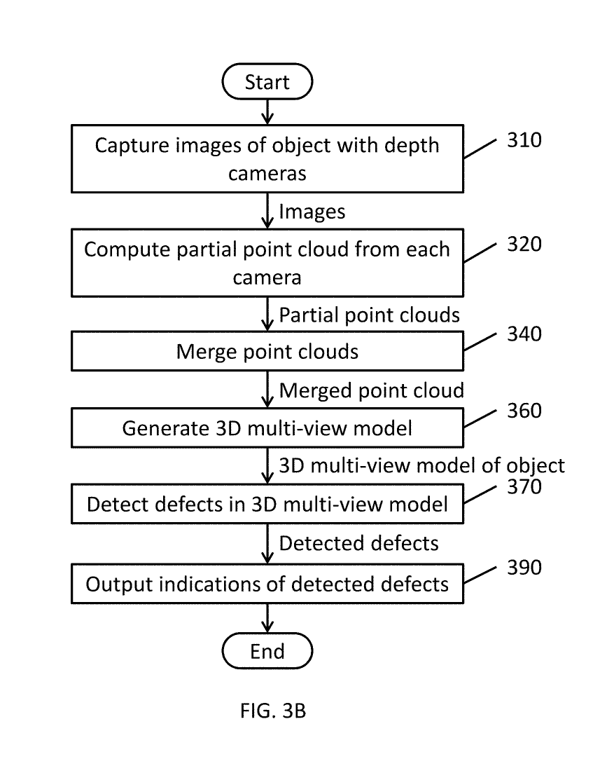

FIG. 3A is a schematic block diagram illustrating a system for defect detection according to one embodiment of the present invention. FIG. 3B is a flowchart of a method for detecting defects according to one embodiment of the present invention. As shown in FIGS. 3A and 3B, in operation 310 the depth cameras 20 image an object 10 (depicted in FIG. 3A as a shoe). The data captured by each of the depth cameras is used in operation 320 by a point cloud generation module 32 to generate a partial point cloud representing the shape of the object 10 as captured from the pose or viewpoint of the corresponding depth camera 20. The point cloud merging module 34 merges the separate partial point clouds in operation 340 to generate a merged point cloud of the entire shoe. The point cloud merging of the separate point clouds from each of the cameras 20 can be performed using, for example, an iterative closest point (ICP) technique (see, e.g., Besl, Paul J., and Neil D. McKay. “A method for registration of 3-D shapes.” IEEE Transactions on pattern analysis and machine intelligence 14.2 (1992): 239-256.). (FIG. 3A merely depicts three cameras 20 imaging only one side of the shoe. However, embodiments of the present invention would generally also image the other side of the shoe in order to generate a complete 3D model of the shoe.)

Iterative Closest Point (ICP) is a method for aligning point clouds by, generally speaking, iteratively rotating and translating the point clouds relative to one another to minimize a mean-square distance metric between matching portions of the point clouds. The ICP technique is particularly effective when an initial, approximately correct pose between the point clouds (equivalently, approximately correct relative poses between the cameras that captured the point clouds) can be provided as input to the ICP technique. In the case of depth cameras 20 having relative poses that are fixed (e.g., by rigidly attaching the depth cameras 20 to a rigid frame), the approximate relative poses of the cameras relative to one another may be available. In addition, the relative poses of the cameras can be computed by simple calibration methods (e.g., metric markings on the frame, goniometers at the camera attachments). In embodiments where each camera 20 includes an inertial measurement unit (IMU) 28, the IMU may also provide pose information (e.g., angle relative to vertical). This information can be used to initialize the ICP process during the merging the point clouds in operation 340, which may thus be able to converge quickly (e.g., merge two point clouds in a few iterations). Calibration of the cameras 20 will be described in more detail below.

In operation 360, a 3D multi-view model generation module 36 (e.g., mesh generation module) generates a 3D multi-view model from the merged point cloud. In some embodiments, the 3D multi-view model is 3D mesh model. Examples of techniques for converting a point cloud to a 3D mesh model include Delaunay triangulation and α-shapes to connect neighboring points of the point clouds using the sides of triangles. In some embodiments, the MeshLab software package is used to convert the point cloud to a 3D mesh model (see, e.g., P. Cignoni, M. Callieri, M. Corsini, M. Dellepiane, F. Ganovelli, G. Ranzuglia MeshLab: an Open-Source Mesh Processing Tool Sixth Eurographics Italian Chapter Conference, pages 129-136, 2008.).

In other embodiments of the present invention, the 3D multi-view model is a merged point cloud (e.g., the merged point cloud generated in operation 340), which may also be decimated or otherwise have points removed to reduce the resolution of the point cloud in operation 360.

In still other embodiments of the present invention, the 3D multi-view model includes two-dimensional (2D) views of multiple sides of the object (e.g., images of all visible surfaces of the object). This is to be contrasted with a stereoscopic pair of images captured of one side of an object (e.g., only the medial of a shoe, without capturing images of the lateral of the shoe), whereas a 3D multi-view model of the object according to these embodiments of the present invention would include views of substantially all visible surfaces of the object (e.g., surfaces that are not occluded by the surface that the object is resting on). For example, a 3D multi-view model of a shoe that includes 2D images of the shoe may include images of the medial side of the shoe, the lateral side of the shoe, the instep side of the shoe, and the heel side of the shoe. The sole of the shoe may not be visible due to being occluded by the surface that the shoe is resting on.

The resulting 3D multi-view model 37 can be measured (for size determination), and, in operation 370, a defect detection module 38 may be used to detect defects in the object based on the generated multi-view model 37. For example, in one embodiment the defect detection module 38 compares the captured 3D multi-view model 37 of the object to a reference model 39 in order to assess the quality of the produced object (e.g., to detect defects in the object) and to compute a quality assessment, which is output in operation 390.

The functionality provided by, for example, the point cloud generation module 32, the point cloud merging module 34, the 3D model generation module 36, and the defect detection module 38 may be implemented using one or more computer processors. The processors may be local (e.g., physically coupled to the cameras 20) or remote (e.g., connected to the cameras 20 over a network). In various embodiments of the present invention, the point cloud generation, the point cloud merging, the 3D model generation, and the defect detection operations may be performed on a local processor or on a remote processor, where the remote processor may be on site (e.g., within the factory) or off-site (e.g., provided by a cloud computing service). Considerations for the distribution of the pipeline of the computation of 3D models based on images captured by depth cameras is described in more detail in U.S. patent application Ser. No. 15/805,107, “System and Method for Portable Active 3D Scanning” filed in the United States Patent and Trademark Office on Nov. 6, 2017, the entire disclosure of which is incorporated by reference herein, and may generally involve tradeoffs regarding, for example, response time, network bandwidth, fixed hardware costs, and recurring computation costs. For the sake of convenience, the term “processor” will be used generally to refer to one or more physical processors, where the one or more physical processor may be co-located (e.g., all local or all remove) or may be separated (e.g., some local and some remote).

Camera Placement

In various embodiments of the present invention, the cameras shown in FIGS. 1A and 1B may be arranged in order to obtain the desired coverage of the object's surface at the desired geometric resolution. These considerations may be specific to the particular application of the defect detection system. For example, some portions of the objects may require higher resolution scans or a higher fidelity model in order to detect defects in the products, while other portions of the objects may not require detailed modeling at all.

The cameras (or depth cameras) 20 may all have the same characteristics (in terms of optical characteristics and pixel resolution), or may have different characteristics (e.g., different focal lengths, different pixel resolutions of their image sensors, different spectra such as visible versus infrared light, etc.). In some embodiments, the cameras 20 are arranged so that they image different portions of the surface of the object. In some embodiments, the fields of view of two or more cameras overlap, resulting in the same surface being imaged by multiple cameras. This can increase the measurement signal-to-noise ratio (SNR) and can also increase the effective geometric resolution of the resulting model.

If the shape of the object to be scanned is known in advance the cameras can be placed a priori to cover all of the surfaces of the object (or a desired portion of the object) with the desired geometric resolution (which, as discussed earlier, may be chosen to be constant over the surface, or variable in accordance with the defect detection requirements). In other situations where the shape of the object is not known in advance, the location of the cameras may be iteratively adjusted manually in order to obtain the desired coverage and resolution. Along with the range cameras, the placement of the color cameras needs to also be considered. A conceptually simple solution would be to place color cameras next to the depth cameras (or integrate the color cameras with the depth cameras such as in the depth camera shown in FIG. 2), so that both the color camera and the depth camera form a “unit” image the substantially the same portion of space. However, embodiments of the present invention are not limited thereto and may also encompass circumstances where, for example, a high resolution color camera having a large field of view could be deployed to image the same area imaged by multiple depth cameras, each having a smaller field of view than the color camera.

The design parameters include: distance of each camera to the surface; field of view of each camera; pixel resolution of each camera; field of view overlap across cameras (measured by the number of cameras that image the same surface element).

Table 1 offers a qualitative overview of the effect of each such parameter on the two quantities of interest: overall surface area covered by all cameras 20 in the system; and geometric resolution of the resulting 3D multi-view model.

TABLE 1

| | Overall Surface Area Covered | Geometric Resolution |
|---|---|---|
| Distance | ↑ | ↓ |
| camera-surface ↑ | | |
| Field of view ↑ | ↑ | ↓ |
| Pixel resolution ↑ | — | ↑ |
| Field of | ↓ | ↑ |
| view overlap ↑ | | |

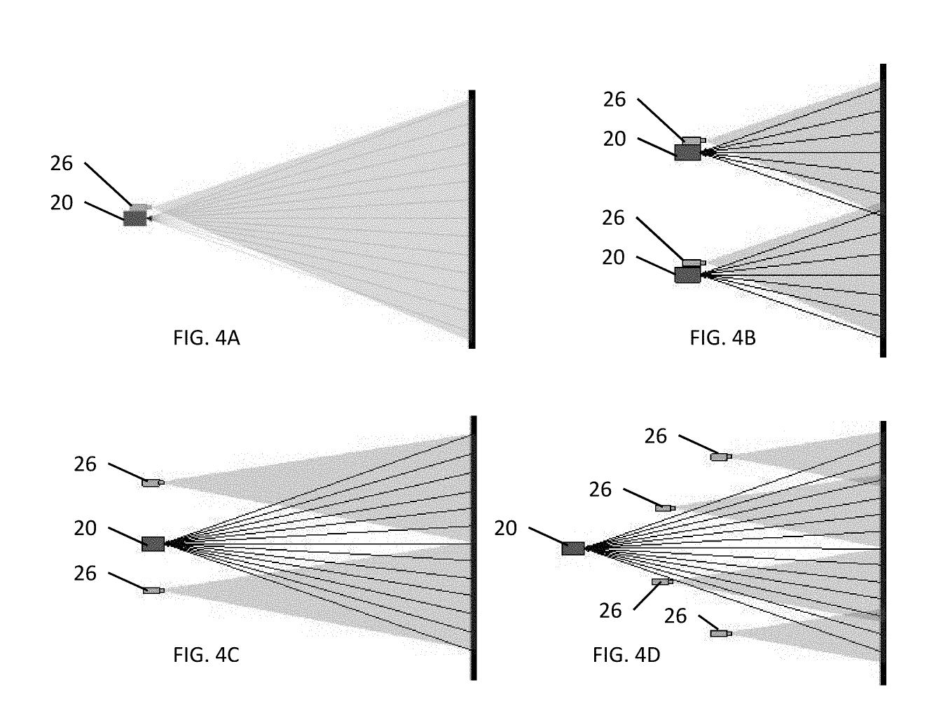

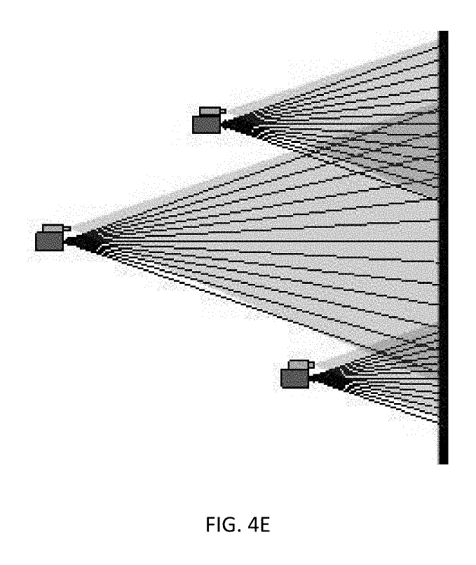

As suggested by Table 1, the same surface coverage at the desired geometric resolution can be obtained with multiple configurations. For example, a high-resolution range camera can substitute for multiple range cameras, placed side-by-side, with lower spatial resolution and narrower field of view. As another example, multiple low-resolution cameras, placed at a close distance to the surface, can substitute for a high-resolution range camera at larger distance (as shown in FIGS. 4A and 4B, respectively).

Embodiments of the present invention also include other arrangements of cameras and illuminators (or projection sources). For example, projection sources may be placed in locations at possibly large distances from the cameras. This may be particularly useful when the field of view of the camera 20 is wide and a large surface area is to be illuminated. Diffractive optical elements (DOE) with wide projection angle may be very expensive to produce; multiple projectors 26 having narrower beams may substitute for a wide beam projector, resulting in a more economical system (see, e.g., FIG. 4C, where two projectors 26 having narrower beams than the projector 26 of FIG. 4A are used with one camera 20 having a wide field of view). Multiple projectors 26 may also be placed at closer distances to the surface than the camera as shown in FIG. 4D). Because the irradiance at the camera is a function of the distance of the projectors to the surface, by placing the projectors closer to the surface, higher irradiance at the camera (and thus higher SNR) can be achieved. The price to pay is that, since the surface area covered by a projector decreases with the distance to the surface, a larger number of projectors may be needed to cover the same amount of surface area.

If a variable geometric resolution is desired, different resolution cameras can be placed at a common distance from the object, or multiple similar cameras can be placed at various distances from the surface, as shown in FIG. 4E, where cameras that are closer to the surface can provide higher geometric resolution that cameras that are farther from the surface.

When evaluating different configurations, the system designer may consider various practical factors, including economic factors. In particular, the cost of the overall system depends both on the number of cameras employed, and on the pixel resolution of these cameras (higher resolution models normally come at premium cost). Other factors include the cost and complexity of networking the cameras together, as well as the computational cost of registering the depth images together.

The quality of stereo matching (and thus the accuracy of reconstructed depth) depends in large part on the quality of the image of the projected texture as seen by the image sensors of a depth camera. This is especially true in the case of otherwise plain surfaces, for which the only information available for stereo matching is provided by the projected pattern. In order for the projector to improve the signal to noise ratio, it generally must generate an irradiance on the camera sensor that is substantially higher than the background irradiance (e.g., ambient light). It is also important that points be dense enough that subtle depth variations can be correctly captured.

The point density measured by a camera with a co-located projector is substantially independent of the distance to the surface. However, the irradiance of the points at the camera decreases with the distance of the projector to the surface. In addition, the irradiance at the camera is proportional to the cosine of the angle formed by the projected ray and the surface normal.

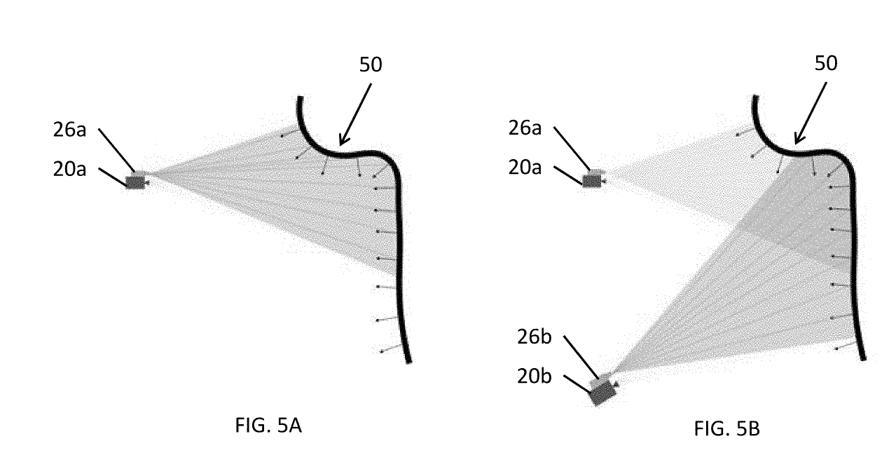

FIGS. 5A and 5B show multiple depth cameras with illuminators illuminating a surface with a curve according to one embodiment of the present invention. As shown in FIG. 5A, when this angle is large (e.g. at the bend in the surface shown above), the resulting SNR may be poor. FIG. 5B shows that the presence of another camera and illuminator may allow the same first camera to image a surface point by adding illumination from a different angle.

For example, in the case shown in FIG. 5A, surface points 50 with a large slant angle with respect to the illumination direction of the illuminator 26a will be imaged with relatively low irradiance by the camera 20a, and thus have poor SNR. This problem can be mitigated by the use of multiple camera/projector units, placed at different spatial locations and with different orientation.

As shown in FIG. 5B, if two depth cameras 20a and 20b, each with its own projector 26a and 26b, have overlapping fields of view, then the light projected by the two projectors will overlap, at least in part, on the same surface portion. As a result, each camera will see, at least for a portion of its field of view, a texture that is generated by either of or both of the individual projectors 26a and 26b. A surface patch (such as patch 50) with a large slant angle with respect to one of the two projectors (e.g., projector 26a), may have a smaller slant angle with respect the other projector (e.g., projector 26b), as shown in FIG. 5B. In this case, illumination by the projector 26b of the second camera 20b would result in an image with improved SNR at the first camera 20a. Projectors and cameras could be controlled to capture multiple images under different illumination conditions. For example, in the case of FIG. 5B, each camera 20 could take a picture with its own projector 26 on; a second picture with the projector of the other camera on; and a third picture with both projectors on. This may be used to advantage for improved range accuracy, by aggregating the resulting point clouds obtained from measurements in the different illumination conditions.

Another common problem with individual multiple camera/projector systems arises when the projector and the camera are placed at a certain physical distance from each other. In some situations, this may cause parts of a surface visible by the camera to receive no light from the projector because they are occluded by another surface element. These situations typically occur at locations with sudden depth variations, resulting in missing or incorrect depth measurement. For this additional reason, use of another light source at a different location may help with illuminating these areas, and thus allow for depth computation in those areas that do not receive light from the first projector.

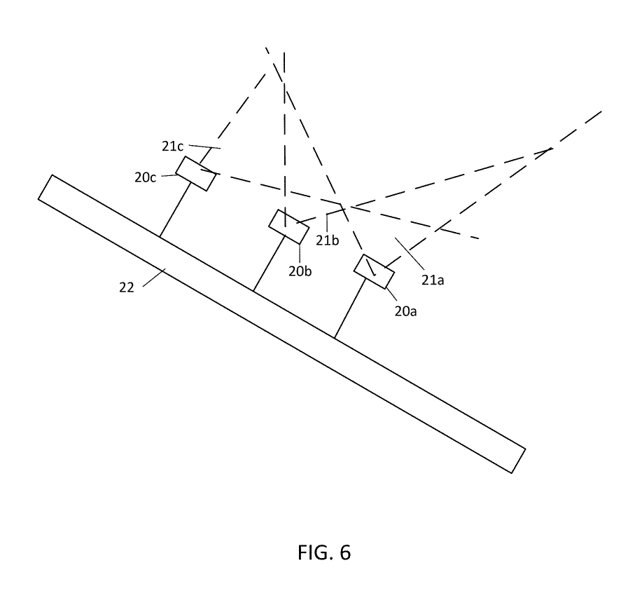

FIG. 6 illustrates a structure of a system with three cameras 20a, 20b, and 20c having overlapping fields of view 21a, 21b, and 21c and having projectors configured to emit patterns in overlapping portions of the scene according to one embodiment of the present invention. The cameras are rigidly connected to a connection bar 22, which may provide power and communications (e.g., for transferring the captured images for processing).

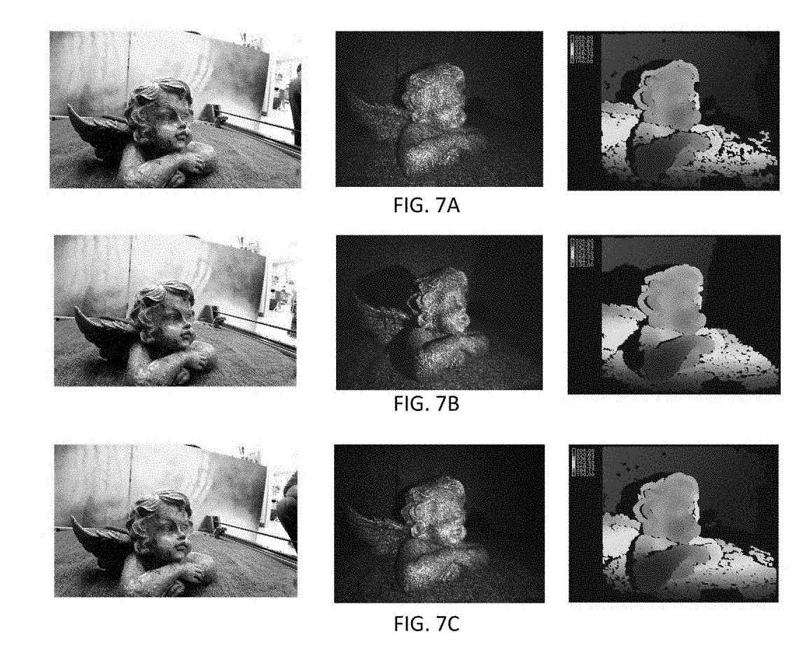

FIGS. 7A, 7B, and 7C illustrate the quality of the depth images generated by the embodiment shown in FIG. 6 with different combinations of projectors being turned on according to one embodiment of the present invention. The left image of FIG. 7A is a color image from one of the two image sensors in the first stereo system of camera 20a in FIG. 6. The center image of FIG. 7A depicts the point pattern produced by the projector 26a co-located with the first stereo camera system 20a from the perspective of the first camera 20a. The right image of FIG. 7A depicts the resulting point cloud with color superimposed. The visible “holes” represent surfaces for which the depth could not be reliably computed.

The left image of FIG. 7B is a color image from one of the two image sensors in the stereo system of first camera 20a in FIG. 6. The center image of FIG. 7B depicts the point pattern produced by the second projector 26b co-located with the second stereo camera system 20b, from the perspective of the first camera 20a. The right image of FIG. 7B depicts the resulting point cloud with color superimposed.

The left image of FIG. 7C is a color image from one of the two image sensors in the stereo system of first camera 20a in FIG. 6. The center image of FIG. 7B depicts the point pattern produced by both the first projector 26a and the second projector 26b co-located with the second stereo camera system 20b, from the perspective of the first camera 20a. With both the first projector 26a and the second projector 26b turned on, a denser point pattern is produced. The right image of FIG. 7C depicts the resulting point cloud with color superimposed. Comparing the right image of FIG. 7C with the right images of FIGS. 7A and 7B, the background (shown in blue) is imaged more fully and the elbow of the statue is imaged with better detail (e.g., fewer holes).

As such, using multiple projectors from multiple angles can further improve the quality of the captured models.

Some aspects of embodiments of the present invention relate to the calibration of the system in accordance with the relative poses (e.g., positions and orientations) of the cameras 20. Suppose that multiple depth images (or range images) are captured of an object 10 from different viewpoints in order to cover the desired portion of the object's surface at the desired resolution. Each depth image may be represented by a cloud of 3-D points, defined in terms of the reference frame induced by the camera 20 at the pose from which each picture was taken. The term “registration” refers to the process of combining multiple different point clouds into a common reference frame, thus obtaining an unambiguous representation of the object's surface (see, e.g., Weinmann, Martin. “Point Cloud Registration.” Reconstruction and Analysis of 3D Scenes. Springer International Publishing, 2016. 55-110.). For example, the point cloud merging operation 340 includes performing a registration of the separate partial point clouds. (The point cloud merging operation 340 may also include other operations such as smoothing of noisy points or decimation of points to achieve a desired density of points in various portions of the merged point cloud.) The fixed reference frame can be placed at an arbitrary location and orientation; it is often convenient to set the fixed reference frame to be the reference frame of one of the cameras (e.g., camera 20a) in the collection of cameras 20.

Registration also applies in the case of a moving object in which several range images are captured (or taken) at different times from one or more fixed cameras 20. This may occur, for example, if the objects to be scanned are placed on a conveyor belt 12, with the depth cameras 20 (e.g., an array of depth cameras) placed at fixed locations (see, e.g., FIGS. 1A and 1B). Another example is that of an object placed on a turntable. Moving an object in front of the camera array may allow the surfaces of the object to be captured using fewer depth cameras along the direction of motion. This is because multiple depth images can be taken of the object while the object is translating (and/or rotating), thereby obtaining a similar result to what would be achieved by a larger number of cameras taking images of the object in a fixed location or orientation. In addition, the ability to capture overlapping range images of the same surface area (if the frame rate is sufficiently high with respect to the object's motion) can be used to reduce noise in the surface estimation.

In one embodiment of the present invention, registration of two or more point clouds (from different cameras imaging at the same object, or of the same moving object imaged by the same camera at different times) involves estimation of the relative pose (rotation and translation) of cameras imaging the same object, or of the relative poses of the camera with respect to the moving object at the different acquisition times. If the cameras are rigidly mounted to a frame (e.g., the connection bar 22) with well-defined mechanical tolerances, then the camera array system may be calibrated before deployment using standard optical calibration methods (e.g., calibration targets). In this context, the term “calibration” refers to estimation of the pairwise relative camera pose (see, e.g., Hartley, Richard, and Andrew Zisserman. Multiple View Geometry In Computer Vision. Cambridge University Press, 2003.).

If the system is designed to allow for manual camera placement or adjustment, calibration may be performed on-site and, periodic re-calibration may be performed to account for unexpected changes (e.g. structural deformation of the mounting frame). On-site calibration may be performed in different ways in accordance with various embodiments of the present invention. In one embodiment, a specific target is imaged by the cameras: one or more depth images of the target are captured by each pair of cameras, from which the pairwise relative poses are computed using standard calibration procedures (see, e.g., Hartley and Zisserman). It is also possible to perform pair-wise calibration from pictures taken of a generic non-planar environment, using structure-from-motion algorithms. These image-based techniques exploit the so-called epipolar constraint (see, e.g., Hartley and Zisserman) on the pictures of the same scene from two different viewpoints to recover the rotation matrix and the translation vector between the cameras (up to a scale factor).

The depth data (or range data) captured by the depth cameras provides an additional modality for geometric registration of the cameras. Geometric registration among the cameras defines the rotation and transformation parameters for the coordinate transformation between the cameras. Therefore, when the camera pose of one camera is estimated relative to the 3D object, the pose of the other cameras relative to the same 3D object can also be estimated if the portions of the 3D object imaged by the cameras are aligned (e.g., merged). In one embodiment, the point clouds generated by two range cameras in the array viewing the same surface portion are matched or aligned through rigid transformations (e.g., translations and rotations without deformation of the point clouds) using techniques such as the Iterative Closest Point, or ICP, algorithm (see, e.g., Besl, Paul J., and Neil D. McKay. “A method for registration of 3-D shapes.” IEEE Transactions on pattern analysis and machine intelligence 14.2 (1992): 239-256.). The ICP algorithm produces an estimation of the relative camera poses, as the transformation of one of the point clouds to cause the matching portions of the point clouds to be aligned corresponds to a transformation between the two cameras that captured the point clouds.

In some embodiments, the image-based and range-based registration techniques are combined to improve the reliability of the calibration. Range-based techniques may be preferable when the images contain only a few “feature points” that can reliably matched across views. Image-based techniques such as those described in Hartley and Zisserman may be more applicable in the case of a planar or rotationally symmetric surface, when point cloud matching may be ambiguous (i.e., multiple relative poses exist which may generate geometrically consistent point cloud overlap). Image-based or range-based recalibration may be conducted periodically (e.g., when there is a reason to believe that the cameras have lost calibration) or when a camera has been re-positioned; or continuously, at each new data acquisition.

In the case of an object moving during range acquisition, in which several range images are taken by one or more cameras, point cloud registration may include estimation of the relative pose of the object across the image acquisition times. This can be achieved again through the use of ICP. Because the object is assumed to move rigidly (e.g., without deformation), the point clouds from two range cameras are (for their overlapping component) also related by a rigid transformation. Application of ICP will thus result in the correct alignment and thus result in an “equivalent” pose registration of the two cameras, enabling surface reconstruction of the moving object. It is important to note that even if each depth camera in a perfectly calibrated array takes only one depth image of a moving object, the resulting point clouds may still need to be registered (e.g. via ICP) if range image acquisition is not simultaneous across all cameras (e.g., if the cameras capture their depth images of the object at different locations on the conveyor belt).

The color cameras of the 3D scanning system may also require geometric registration. In some embodiments, the color cameras are rigidly attached to the range cameras, forming a “unit” that can be accurately calibrated prior to deployment (e.g., the color cameras can be calibrated with respect to the infrared cameras of the same unit). Systems and methods for calibrating color and infrared cameras that are rigidly integrated into a unit are described, for example, in United States Patent and Trademark Office on May 5, 2016, issued on Jun. 6, 2017 as U.S. Pat. No. 9,674,504, the entire disclosure of which is incorporated by reference. In some embodiments, time synchronization is used to register a color image and a range image of moving objects. Note that in the case of fully integrated range/color camera units, time synchronization can be easily achieved via electrical signaling. If the color and the range cameras cannot be synchronized, proper geometric registration between color and range image can be achieved by precisely time-stamping the images, and estimating the object motion between the time stamps of the images (e.g., if the timestamps are synchronized with the movement of the conveyor belt 12). In this case, point clouds can be rigidly transformed to account for the time lag between the range and color image acquisition (e.g., translated in accordance with the speed of movement of the object multiplied by the difference in the time stamps).

Table 2 summarizes the benefit of using multiple cameras in combination with the respective multiple projectors in creating a superior point cloud in summarized in the table below. An upward arrow indicates an increment of the corresponding quantity.

TABLE 2

| | | | Quality of |
|---|---|---|---|
| Projector | Projector | Projector | aggregate |
| 1 | 2 | 1 + 2 | point cloud |

| | | | | | |
|---|---|---|---|---|---|
| Cam 1 | ✓ | | | | ↑ |
| | | | | {close oversize brace} | |
| Cam 2 | | ✓ | | | |
| Cam 1 | ✓ | ✓ | ✓ | | ↑↑ |
| | | | | {close oversize brace} | |
| Cam 2 | ✓ | ✓ | ✓ | | |

Detecting Defects in the 3D Multi-View Model

Referring to FIG. 3B, in operation 370 the defect detection module 38 analyzes the 3D multi-view model generated in operation 360 to detect defects. Some methods of defect detection are described in U.S. patent application Ser. No. 15/678,075 “System and Method for Three-Dimensional Scanning and for Capturing a Bidirectional Reflectance Distribution Function” filed in the United States Patent and Trademark office on Aug. 15, 2017, the entire disclosure of which is incorporated by reference herein.

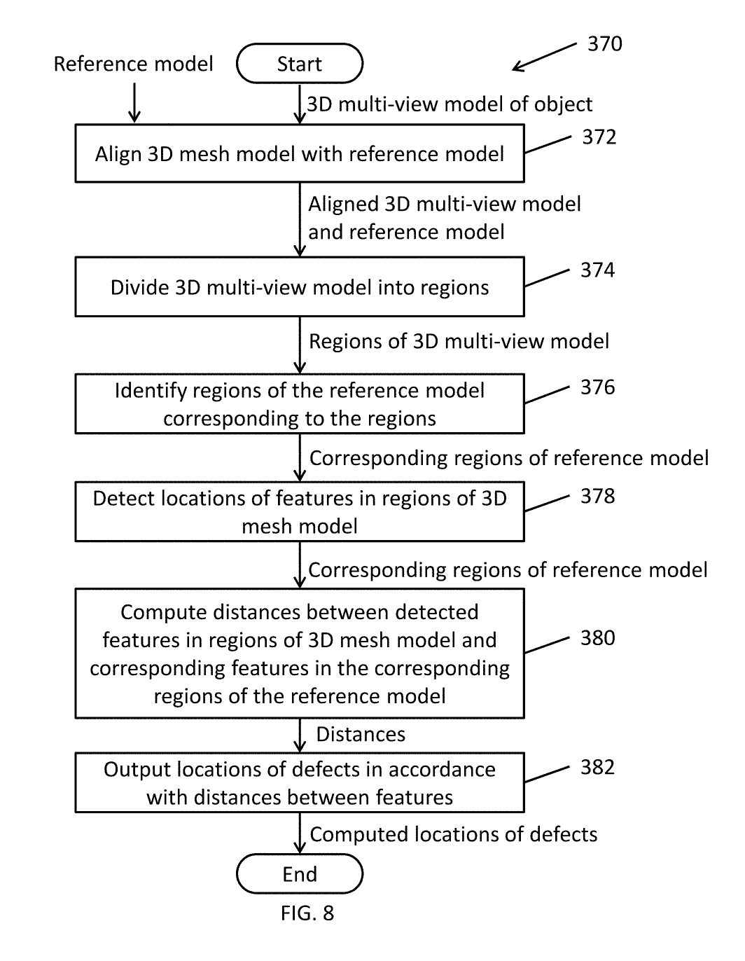

In one embodiment, the defect detection module 38 compares the scanned 3D multi-view model 37 to a reference model 39 and the defects are detected in accordance with differences between the scanned 3D multi-view model 37 and the reference model 39. FIG. 8 is a flowchart of a method 370 for performing defect detection according to one embodiment of the present invention.

In operation 372, the defect detection module 38 aligns the scanned 3D multi-view model 37 and the reference model 39. In cases where the 3D multi-view model is a 3D mesh model or a 3D point cloud, a technique such as iterative closest point (ICP) can be used to perform the alignment. Techniques for aligning models are also described in U.S. patent application Ser. No. 15/630,715 “Systems and methods for scanning three-dimensional objects,” filed in the United States Patent and Trademark Office on Jun. 22, 2017, the entire disclosure of which is incorporated herein by reference. In embodiments where the 3D multi-view model is a collection of 2D images, the alignment may include identifying one or more poses with respect to the reference model 39 that correspond to the views of the object depicted in the 2D images based on matching shapes depicted in the 2D images with shapes of the reference model and based on the relative poses of the cameras with respect to the object when the 2D images were captured.

In operation 374, the defect detection module 38 divides the 3D multi-view model 37 (e.g., the surface of the 3D multi-view model) into regions. For example, in the case of a shoe, each region may correspond to a particular section of interest of the shoe, such as a region around a manufacturer's logo on the side of the shoe, a region encompassing the stitching along a seam at the heel of the shoe, and a region encompassing the instep of the shoe. In some embodiments, all of the regions, combined, encompass the entire visible surface of the model, but embodiments of the present invention are not limited thereto and the regions may correspond to regions of interest making up less than the entire shoe.

As more specific examples, in embodiments where the 3D multi-view model is a 3D mesh model, the region may be a portion of the surface of the 3D mesh model (e.g., a subset of adjacent triangles from among all of the triangles of the 3D mesh model). In embodiments where the 3D multi-view model is a point cloud, the region may be a collection of adjacent points. In embodiments where the 3D multi-view model is a collection of 2D images, the region may correspond to the portions of each of the separate 2D images that depict the particular region of the object (noting that the region generally will not appear in all of the 2D images, and instead will only appear in a subset of the 2D images).

In operation 376, the defect detection module 38 identifies corresponding regions of the reference model. These regions may be pre-identified (e.g., stored with the reference model), in which case the identifying the corresponding regions in operation 376 may include accessing the regions. In some embodiments, corresponding regions of the reference model 39 are regions that have substantially similar features as their corresponding regions of the scanned 3D multi-view model 37. The features may include particular color, texture, and shape detected in the scanned 3D multi-view model. For example, a region may correspond to the toe box of a shoe, or a location at which a handle of a handbag is attached to the rest of the handbag. In some embodiments, one or more features of the region of the scanned 3D multi-view model 37 and the region of the reference model 39 may have substantially the same locations (e.g., range of coordinates) within their corresponding regions. For example, the region containing the toe box of the shoe may include the eyelets of the laces closest to the shoe on one side of the region, the tip of the shoe on the other side of the region.

In embodiments of the present invention where the 3D multi-view model 37 is a 3D mesh model and in embodiments of the present invention where the 3D multi-view model 37 is a point cloud, the region may be, respectively, a collection of adjacent triangles or a collection of adjacent points. In embodiments of the present invention where the 3D multi-view model 37 is a collection of 2D images and where the reference model 39 is a 3D model, the corresponding regions of the reference model 39 may be identified by rendering 2D views of the reference model 39 from the same relative poses as those of the camera(s) when capturing the 2D images of the object to generate the 3D multi-view model 37.

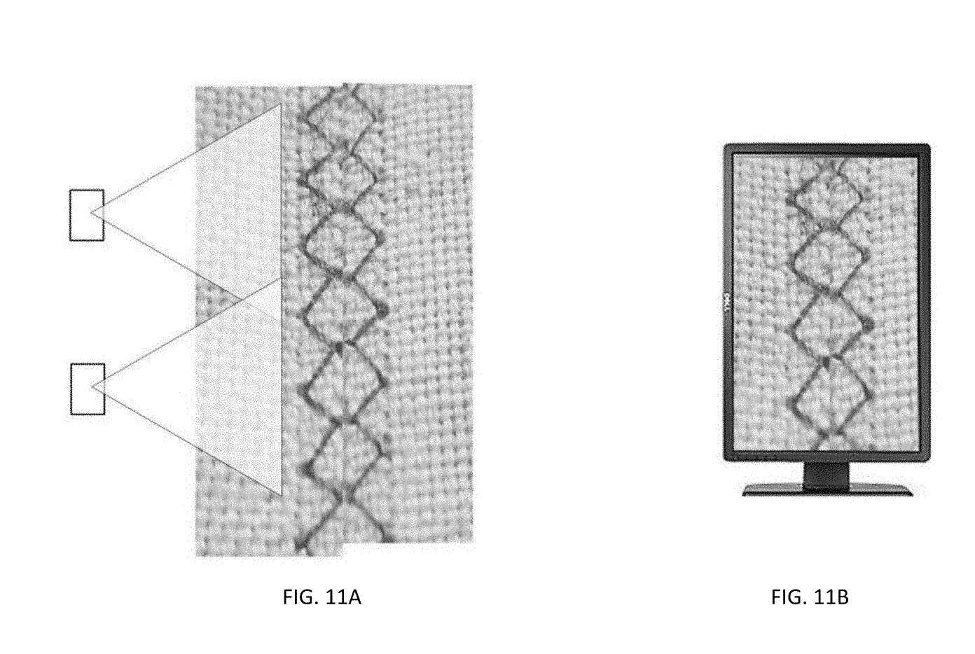

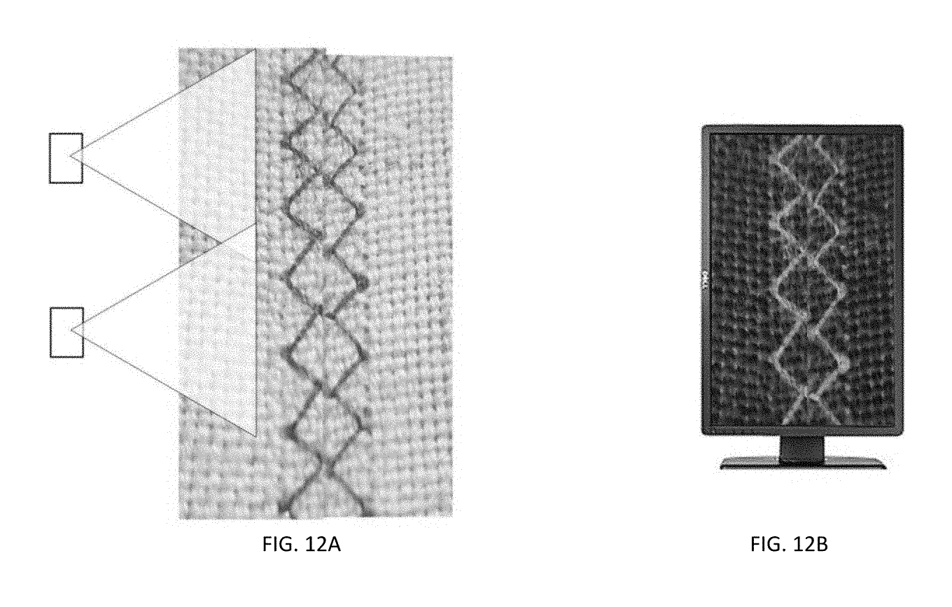

In operation 378, the defect detection module 38 detects locations of features in the regions of the regions of the 3D multi-view model. The features may be pre-defined by the operator as items of interest within the shape data (e.g., three dimensional coordinates) and texture data (e.g., surface color information) of the 3D multi-view model and the reference model. In various embodiments, aspects of the features may relate to geometric shape, geometric dimensions and sizes, surface texture and color. One example of a feature is a logo on the side of a shoe. The logo may have a particular size, geometric shape, surface texture, and color (e.g., the logo may be a red cloth patch of a particular shape that is stitched onto the side of the shoe upper during manufacturing). The region containing the logo may be a defined by a portion of the shoe upper bounded above by the eyelets, below by the sole, and to the left and right by the toe box and heel of the shoe. The defect detection module 38 may detect the location of the logo within the region (e.g., a bounding box containing the logo and/or coordinates of the particular parts of the logo, such as points, corners, patterns of colors, or combinations of shapes such as alphabetic letters). Another example of a feature may relate to the shape of stitches between two pieces of cloth (see, e.g., FIGS. 11A, 11B, 12A, and 12B). In such a case, the features may be the locations of the stitches (e.g., the locations of the thread on the cloth within the region). Still another feature may be an undesired feature such as a cut, blemish, or scuff mark on the surface. According to one embodiment of the present invention, the features are detected using a convolutional neural network (CNN) that is trained to detect a particular set of features that are expected to be encountered in the context of the product (e.g., logos, blemishes, stitching, shapes of various parts of the object, and the like), which may slide a detection window across the region to classify various portions of the region as containing one or more features.

In operation 380, the defect detection module 38 computes distances (or “difference metrics”) between detected features in regions of 3D multi-view model and corresponding features in the corresponding regions of the reference model. Referring back to the example of the location of a logo (as a feature of interest) on the side of the shoe, the location of the feature (e.g., the corners of the bounding box) in the region of the 3D multi-view model 37 is compared with the location of the feature (e.g., the corners of its bounding box) in the corresponding region of the reference model 39 and a distance is computed in accordance with the locations of those features (e.g., as an L1 or Manhattan distance or as a mean squared error between the coordinates). As such, the defects can be detected and characterized in the extent or magnitude of the differences in geometric shape, geometric dimensions and sizes, surface texture and color from a known good (or “reference” sample) or other based on similarity to known defective samples. These features may correspond to different types or classes of defects, such as defects of blemished surfaces, defects of missing parts, defects of uneven stitching, and the like.

The defect detection may be made on a region-by-region basis of the scanned multi-view model 37 and the reference model 39. For example, when comparing a scanned multi-view model 37 of a shoe with a reference model 39 of the shoe, the comparison may show the distance between the reference position of a logo on the side of the shoe with the actual position of the logo in the scanned model. As another example, the comparison may show the distance between the correct position of an eyelet of the shoe and the actual position of the eyelet.

In some instances, features may be missing entirely from the scanned model 37, such as if the logo was not applied to the shoe upper during manufacturing. Similarly, features may be detected in the regions of the scanned model 37 that do not exist in the reference model, such as if the logo is applied to a region that should not contain the logo, or if there is a blemish in the region (e.g., scuff marks and other damage to the material). In these cases, in one embodiment, a large distance or difference metric is returned as the computed distance (e.g., a particular, large fixed value) to in order to indicate the complete absence of a feature that is present in the reference model 29 or presence of a feature that is absent from the reference model 39.

If the differences between the scanned model and the reference model exceed a threshold value, then the quality control system may flag the scanned object as falling outside of the quality control standards in operation 390. For example, if the location of the logo deviates from the location of the logo in the reference model by more than the threshold distance (where the threshold distance corresponds to an acceptable tolerance level set by the manufacturer). For example, the output of the system may include an indication of the region or regions of the scanned 3D multi-view model 37 containing detected defects. In addition, the particular portions of the regions representing the detected defect may also be indicated as defective (rather than the entire region). In some embodiments, a defectiveness metric is also output, rather than merely a binary “defective” or “clean” indication. The defectiveness metric may be based on the computed distances, where a larger distance indicates a larger value in the defectiveness metric.

In some embodiments of the present invention, the defect detection is performed using a neural network trained to detect defects. Given a database of entries in which the visual information is encoded as (imperfect) three-dimensional models, it is possible to automatically populate the metadata fields for the scanned three-dimensional model by querying the database. See, e.g., U.S. patent application Ser. No. 15/675,685 “Systems and Methods for Automatically Generating Metadata for Media Documents,” filed in the United States Patent and Trademark Office on Aug. 11, 2017; U.S. patent application Ser. No. 15/805,107 “System And Method for Portable Active 3D Scanning,” filed in the United States Patent and Trademark Office on Nov. 6, 2017; and U.S. Provisional Patent Application No. 62/442,223 “Shape-Based Object Retrieval and Classification,” filed in the United States Patent and Trademark Office on Jan. 4, 2017, the entire disclosures of which are incorporated by reference herein.

The problem of querying a database of visual information, and in particular of images generally assumes two different forms: image classification (the problem of assigning one or more classes to an image); and image retrieval (the problem of identifying the most similar image entry in the database with respect to the query image). One commonly used image database is ImageNet (see, e.g., Deng, Jia, et al. “ImageNet: A large-scale hierarchical image database.” Computer Vision and Pattern Recognition, 2009. CVPR 2009. IEEE Conference on. IEEE, 2009. and http://www.image-net.org), which includes millions of images and thousands of different classes. See also A. Krizhevsky, I. Sutskever, G. E. Hinton, “ImageNet classification with deep convolutional neural networks”, Advances in Neural Information Processing Systems, 2012 and L. Fei-Fei, P. Perona, “A Bayesian hierarchical model for learning natural scene categories”, CVPR, 2005.

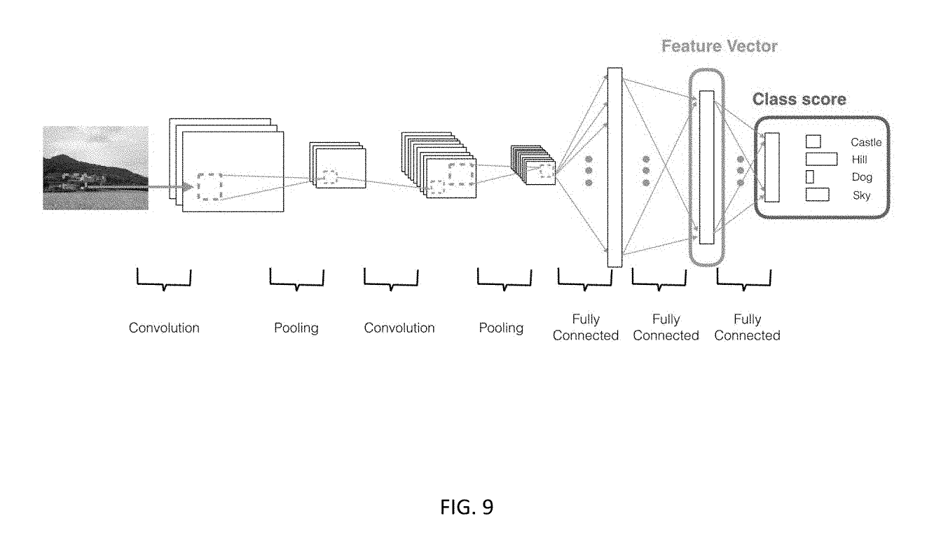

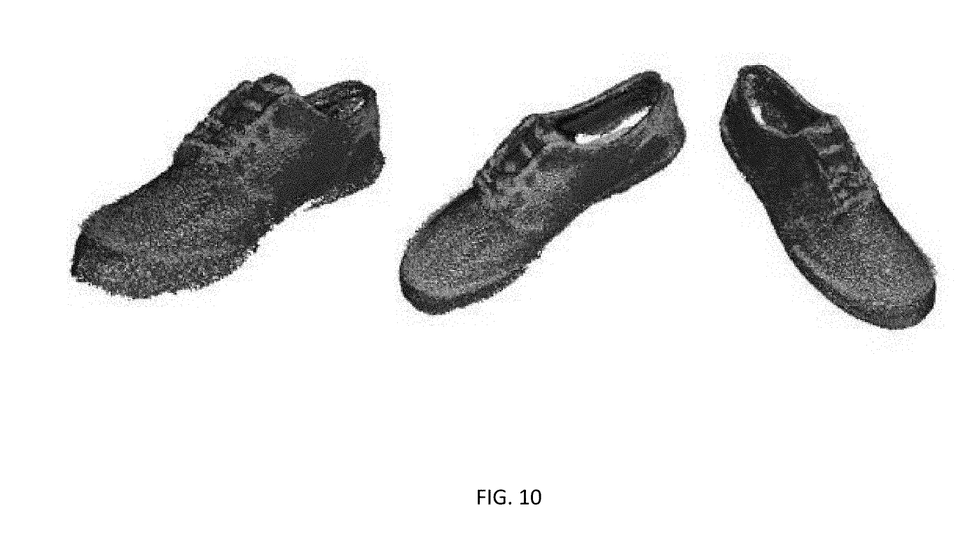

Convolutional Neural Network (CNN) techniques are frequently used to perform image classification. As a non-limiting example, a CNN can be regarded as a system that, given an input image, performs a set of operations such as 2D-convolutions, non-linear mapping, max-pooling aggregations and connections to obtain a vector of values (commonly called a feature vector), which is then used by a classifier (e.g., a SoftMax classifier) in order to obtain an estimate of one or more classes of metadata (e.g., different types of defects) for the input image. FIG. 9 is a schematic representation of a CNN that may be used in accordance with embodiments of the present invention. See also A. Krizhevsky, I. Sutskever, G. E. Hinton, “Imagenet classification with deep convolutional neural networks”, Advances in Neural Information Processing Systems, 2012, Y. LeCun, B. Boser, J. S. Denker, D. Henderson, R. E. Howard, W. Hubbard, L. D. Jackel, “Backpropagation applied to handwritten zip code recognition”, Neural Computation, 1989, and C. Szegedy, W. Liu, Y. Jia, P. Sermanet, S. Reed, D. Anguelov, D. Erhan, V. Vanhoucke, A. Rabinovich, “Going deeper with convolutions”, CVPR, 2015.

Convolutional neural networks are able to provide very accurate class labels estimates (>90% estimation correctness). Each component or layer of a CNN system is characterized by a one or more parameters that are estimated during a training stage. In particular, in the training stage, the CNN is provided with a large set of training images with associated class label and the weights of the connections between these layers are tuned in order to maximize the accuracy of the class prediction for this set of training images. This is a very complex operation (typically involving several hours of computation on extremely powerful graphical processing units or GPUs) because the set of images used for training is usually in the order of 1 million or more and the number of parameters in the CNN is in the order 100 thousand or more. One example of a technique for training a neural network is the backpropagation algorithm.

In more detail, in some embodiments of the present invention, a CNN may be trained to detect various types of defects, where the training set includes 3D models of the objects where defects are to be detected (or various regions of the objects). In some embodiments of the present invention, the 3D model is supplied as input to the CNN. In other embodiments of the present invention, 2D renderings of the 3D multi-view model from various angles are supplied as input to the CNN (e.g., renderings from sufficient angles to encompass the entire surface area of interest). (In embodiments where the 3D multi-view model includes a plurality of 2D images, the “2D renderings” may merely be one or more of those 2D images.) In still other embodiments of the present invention, the separate regions of the models (e.g., as described above with respect to FIG. 8 and operations 374 and 376) are supplied as the inputs to the CNN. The training set includes examples of clean (e.g., defect free objects) as well as examples of defective objects with labels of the types of defects present in those examples.

In some embodiments, the training set is generated by performing 3D scans of actual defective and clean objects. In some embodiments, the training set also includes input data that is synthesized by modifying the 3D scans of the actual defective and clean objects and/or by modifying a reference model. These modifications may include introducing blemishes and defects similar to what would be observed in practice. As a specific example, one of the scanned actual defective objects may be a shoe that is missing a grommet in one of its eyelets. However, in practice, any of the eyelets may be missing a grommet, and there may be multiple missing grommets. As such, additional training examples can be generated, where these training examples include every combination of the eyelets having a missing grommet.

Generally, the process of training a neural network also includes validating the trained neural network by supplying a validation set of inputs to the neural network and measuring the error rate of the trained neural network on the validation set. In some embodiments, if the validation error rate and a training error rate (e.g., the error rate of the neural network when given the training set as input) fail to satisfy a threshold, the system may generate additional training data different from the existing training examples using the techniques of modifying the 3D models of the training data to introduce additional defects of different types. A final test set of data may be used to measure the performance of the trained neural network.

During operation, the trained CNN may be applied to extract a feature vector from a scan of an object under inspection. The feature vector may include color, texture, and shape detected in the scan of the object. The classifier may assign a classification to the object, where the classifications may include being defect-free (or “clean”) or having one or more defects. Some examples of techniques for extracting feature vectors from 3D models are described in “Systems and methods for automatically generating metadata for media documents,” U.S. patent application Ser. No. 15/675,684, filed in the United States Patent and Trademark Office on Aug. 11, 2017, the entire disclosure of which is incorporate by reference herein.

As such, in some embodiments, a neural network is used in place of computing distances or a difference metric between the scanned 3D multi-view model 37 and the reference model 39 by instead supplying the scanned 3D multi-view model 37 (or rendered 2D views thereof or regions thereof) to the trained convolutional neural network, which outputs the locations of defects in the scanned 3D multi-view model 37, as well as a classification of each defect as a particular type of defect from a plurality of different types of defects.

In some embodiments of the present invention, defects are detected using an anomaly detection or outlier detection algorithm. For example, the features in a feature vector of each of the objects may fall within a particular previously observed distribution (e.g., a Gaussian distribution). As such, while most features will have values within a particular range (e.g., a typical range), some objects will have features having values at the extremities of the distribution. In an anomaly detection system, objects having features of their feature vectors with values in the outlier portions of the distribution are detected as having defects in those particular features.

In some embodiments methods similar to multi-dimensional scaling (MDS) are used. Multi-dimensional scaling is a form of non-linear dimensionality reduction, and, in some embodiments, all or a portion of the 3D surface of the scanned model of the object is converted (e.g., mapped) onto a two-dimensional (2D) representation. In this mapping, the geodesic distances among the 3D surface points (that may include surface defects) are substantially maintained in the 2D representation. Representing all, or a portion, of the 3D surface using a 2D encoding allows the use of conventional convolutional neural network (CNN) techniques that are designed to be performed on 2D images. Because the 2D representation substantially maintains the 3D distances between the points, the defects that are categorized by actual real-world sizes can also be detected.

User Interfaces

Some aspects of embodiments of the present invention relate to user interfaces for interacting with a defect detection system according to embodiments of the present invention. For example, quality assurance operator of a factory may use the defect detection system to monitor the quality of products during various stages of manufacturing, where the defect detection system may be used to generate reports and to highlight defects in the objects produced at the factory.

In one embodiment, the surface defects are highlighted and projected onto the image of the product under inspection (e.g., using a video projector or using a laser projector). The severity of the defect can be communicated with various color coding and other visual, textual or audio means. In some embodiments of the present invention, the scanned 3D multi-view model 37 is displayed to the quality assurance operator (e.g., on a separate display device, on a smartphone or tablet, on a heads-up display, and/or in an augmented reality system). The operator monitoring the inspection process may for example, choose to confirm the defect (and thereby reject the particular defective instance of the object), accept it, or mark it for further analysis (or inspection). FIG. 10 illustrates a portion of a user interface displaying defects in a scanned object according to one embodiment of the present invention, in particular, three views of a shoe, where the color indicates the magnitude of the defects. As shown in FIG. 10, portions of the shoe that are defective are shown in red, while portions of the shoe that are clean are shown in green.

FIG. 11A is a schematic depiction of depth cameras imaging stitching along a clean seam. By applying a defect detection technique according to embodiment of the present invention, such as the technique described above with respect to FIG. 3, the defect detection system analyzes the scanned seam to ensure a particular level of quality and normality. FIG. 11B is a schematic depiction of a user interface visualizing the imaged clean seam according to one embodiment of the present invention. In this case, because the seams meets certain pre-defined quality thresholds (e.g., the distances between the locations of the stitches in the scanned model and the location of the stitches in the reference model is below a threshold), a normal color image of the seam is displayed on the monitor.

FIG. 12A is a schematic depiction of depth cameras imaging stitching along a defective seam and FIG. 12B is a schematic depiction of a user interface visualizing the imaged defective seam according to one embodiment of the present invention. Referring to FIG. 12A, the cameras may capture another instance of the product where the seams appear to violate an acceptable alignment (e.g., the points of the zigzag seam are not adjacent). As such, the defect detection system according to embodiments of the present invention detects the abnormality and alerts the operator by displaying the part of the object that is defective. In the example shown in FIG. 12B, the colors in the defective region (here, the entire image) are inverted.

In some embodiments, in response to the output shown in FIG. 11B the operator may choose to override the defect detection system and report that there is a problem with the seam. In such a case, the particular example may be retained and used to retrain the defect detection system to detect this type of defect. The operator may also confirm the output of the defect detection system (e.g., agree that the seam is clean). In some embodiments, no operator input is necessary to confirm that the object is clean (because most objects are likely to be clean).

In some embodiments, in response to the output shown in FIG. 12B, the operator may agree with the defect detection system (e.g., flag the defective part as being defective), or rate the defect (e.g. along a numerical quality scale such as from 1 to 5), or accept the defect as being acceptable by deciding that the defect is within a broader specification of the product defects. As above, if the operator disagrees with the output of the defect detection system, the particular model and the operator's rating may be saved for retraining of the defect detection system.

In some embodiments of the present invention, the defect detection system is retrained or updated live (or “online”). For example, in the case of convolutional neural network-based defect detection, the CNN may be retrained to take into account the new training examples received during operation. As such, embodiments of the present invention allow the defect detection system to learn and to improve based on guidance from the human quality assurance operator.

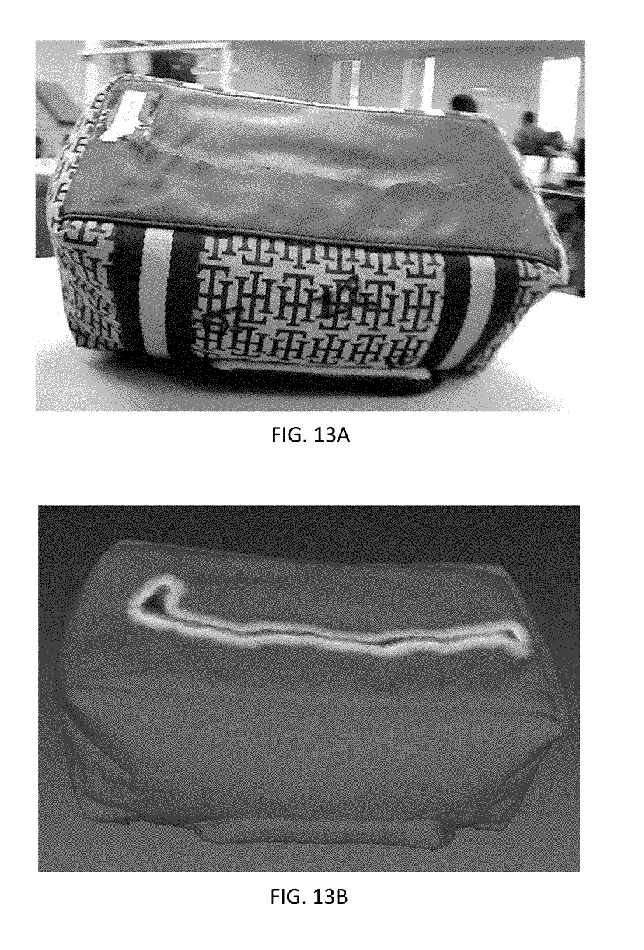

FIG. 13A is a photograph of a handbag having a tear in its base and FIG. 13B is a heat map generated by a defected detection system according to one embodiment of the present invention, where portions of the heat map rendered in red correspond to areas containing a defect and areas rendered in blue correspond to areas that are clean. The heat map shown in FIG. 13B and overlaid on the 3D multi-view model is another example of a depiction of a detected defect on a user interface according to embodiments of the present invention. As shown in FIG. 13B, the portions of the base of the handbag that have the tear are colored in red in the heat map, thereby indicating the location of the defect in the handbag.

As discussed above, the defects are detected and characterized in the extent or magnitude of the differences in geometric shape, geometric dimensions and sizes, surface texture and color from a known good (or “reference” sample) in the scanned 3D model or other based on similarity between the scanned 3D model and known defective samples. The scanned 3D model is generated from aggregating the information from a least two depth, color, or depth/color (RGBZ) cameras, and in some embodiments, from a plurality such cameras. The model is accurate to 1-2 mm depth such that it can detect defects in the construction of the surface by inspecting the shape, size and depth of creases. Creases that have ornamental purposes are not treated as defects because they correspond to features in the reference model or features in the training set of clean objects, while creases that are due to perhaps sewing problems in the seams are flagged as defects because such creases do not appear in the reference model or because such creases appear only in objects in the training set that are labeled as defective.

The defect detection system may be used to control a conveyor system, diverter, or other mechanical device within the factory in order to remove defective objects for inspection, repair, or disposal while allowing clean objects to continue along a normal processing route (e.g., for packaging or to the next step of the manufacturing process).

As such, aspects of embodiments of the present invention are directed to the automatic detection of defects in objects. Embodiments of the present invention can be applied in environments such as factories in order to assist in or to completely automate a quality assurance program, thereby improving the effectiveness of the quality assurance by reducing the rate at which defects improperly pass inspection, by reducing the cost of staffing a quality assurance program (by reducing the number of humans employed in such a program), as well as by reducing the cost of processing customer returns due to defects.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method for detecting a defect in an object, the method comprising:
capturing, by one or more depth cameras, a plurality of partial point clouds of the object from a plurality of different poses with respect to the object;
merging, by a processor, the partial point clouds to generate a merged point cloud;
computing, by the processor, a three-dimensional (3D) multi-view model of the object;
detecting, by the processor, one or more defects of the object in the 3D multi-view model; and
outputting, by the processor, an indication of the one or more defects of the object.

2. The method of claim 1, wherein the detecting the one or more defects comprises:
aligning the 3D multi-view model with a reference model;
comparing the 3D multi-view model to the reference model to compute a plurality of differences between corresponding regions of the 3D multi-view model and the reference model; and
detecting the one or more defects in the object when one or more of the plurality of differences exceeds a threshold.

3. The method of claim 2, wherein the comparing the 3D multi-view model to the reference model comprises:
dividing the 3D multi-view model into a plurality of regions;
identifying corresponding regions of the reference model;
detecting locations of features in the regions of the 3D multi-view model;
computing distances between detected features in the regions of the 3D multi-view model and locations of features in the corresponding regions of the reference model; and
outputting the distances as the plurality of differences.

4. The method of claim 1, further comprising:
computing a plurality of features based on the 3D multi-view model, the features comprising color, texture, and shape; and
assigning a classification to the object in accordance with the plurality of features, the classification comprising one of:
one or more classifications, each classification corresponding to a different type of defect; and
a clean classification.

5. The method of claim 4 wherein the computing the plurality of features comprises:
rendering one or more two-dimensional views of the 3D multi-view model; and
computing the plurality of features based on the one or more two-dimensional views of the object.

6. The method of claim 4, wherein the computing the plurality of features comprises:
dividing the 3D multi-view model into a plurality of regions; and
computing the plurality of features based on the plurality of regions of the 3D multi-view model.

7. The method of claim 4, wherein the assigning the classification to the object in accordance with the plurality of features is performed by a convolutional neural network, and
wherein the convolutional neural network is trained by:
receiving a plurality of training 3D models of objects and corresponding training classifications;
computing a plurality of feature vectors from the training 3D models by the convolutional neural network;
computing parameters of the convolutional neural network;
computing a training error metric between the training classifications of the training 3D models with outputs of the convolutional neural network configured based on the parameters;
computing a validation error metric in accordance with a plurality of validation 3D models separate from the training 3D models;
in response to determining that the training error metric and the validation error metric fail to satisfy a threshold, generating additional 3D models with different defects to generate additional training data;
in response to determining that the training error metric and the validation error metric satisfy the threshold, configuring the neural network in accordance with the parameters;
receiving a plurality of test 3D models of objects with unknown classifications; and
classifying the test 3D models using the configured convolutional neural network.

8. The method of claim 4, wherein the assigning the classification to the object in accordance with the plurality of features is performed by:
comparing each of the features to a corresponding previously observed distribution of values of the feature;
assigning the clean classification in response to determining that all of the values of the features are within a typical range; and
assigning a defect classification for each feature of the plurality of features that are in outlier portions of the corresponding previously observed distribution.

9. The method of claim 1, further comprising displaying the indication of the one or more defects on a display device.

10. The method of claim 9, wherein the display device is configured to display the 3D multi-view model, and
wherein the one or more defects are displayed as a heat map overlaid on the 3D multi-view model.

11. The method of claim 1, wherein the indication of the one or more defects of the object controls movement of the object out of a normal processing route.

12. The method of claim 1, wherein the object is located on a conveyor system, and
wherein the one or more depth cameras are arranged around the conveyor system to image the object as the object moves along the conveyor system.

13. The method of claim 12, wherein the point clouds are captured at different times as the object moves along conveyor system.

14. The method of claim 1, wherein the 3D multi-view model comprises a 3D mesh model.

15. The method of claim 1, wherein the 3D multi-view model comprises a 3D point cloud.

16. The method of claim 1, wherein the 3D multi-view model comprises a plurality of two-dimensional images.

17. A system for detecting a defect in an object, the system comprising:
a plurality of depth cameras arranged to have a plurality of different poses with respect to the object;
a processor in communication with the depth cameras; and
a memory storing instructions that, when executed by the processor, cause the processor to.
receive, from the one or more depth cameras, a plurality of partial point clouds of the object from the plurality of different poses with respect to the object;
merge the partial point clouds to generate a merged point cloud;
compute a three-dimensional (3D) multi-view model of the object;
detect one or more defects of the object in the 3D multi-view model; and
output an indication of the one or more defects of the object.

18. The system of claim 17, wherein the memory further stores instructions that, when executed by the processor, cause the processor to detect the one or more defects by:
aligning the 3D multi-view model with a reference model;
comparing the 3D multi-view model to the reference model to compute a plurality of differences between corresponding regions of the 3D multi-view model and the reference model; and
detecting the one or more defects in the object when one or more of the plurality of differences exceeds a threshold.

19. The system of claim 18, wherein the memory further stores instructions that, when executed by the processor, cause the processor to compare the 3D multi-view model to the reference model by:
dividing the 3D multi-view model into a plurality of regions;
identifying corresponding regions of the reference model;
detecting locations of features in the regions of the 3D multi-view model;
computing distances between detected features in the regions of the 3D multi-view model and locations of features in the corresponding regions of the reference model; and
outputting the distances as the plurality of differences.

20. The system of claim 17, wherein the memory further stores instructions that, when executed by the processor, cause the processor to:
compute a plurality of features based on the 3D multi-view model, the features comprising color, texture, and shape; and
assign a classification to the object in accordance with the plurality of features, the classification comprising one of:
one or more classifications, each classification corresponding to a different type of defect; and
a clean classification.

21. The system of claim 20, wherein the memory further stores instructions that, when executed by the processor, cause the processor to:
render one or more two-dimensional views of the 3D multi-view model; and
compute the plurality of features based on the one or more two-dimensional views of the object.

22. The system of claim 20, wherein the memory further stores instructions that, when executed by the processor, cause the processor to compute the plurality of features by:
dividing the 3D multi-view model into a plurality of regions; and
computing the plurality of features based on the plurality of regions of the 3D multi-view model.

23. The system of claim 20, wherein the memory further stores instructions that, when executed by the processor, cause the processor to assign the classification to the object using a convolutional neural network, and
wherein the convolutional neural network is trained by:
receiving a plurality of training 3D models of objects and corresponding training classifications;
computing a plurality of feature vectors from the training 3D models by the convolutional neural network;
computing parameters of the convolutional neural network;
computing a training error metric between the training classifications of the training 3D models with outputs of the convolutional neural network configured based on the parameters;
computing a validation error metric in accordance with a plurality of validation 3D models separate from the training 3D models;
in response to determining that the training error metric and the validation error metric fail to satisfy a threshold, generating additional 3D models with different defects to generate additional training data;
in response to determining that the training error metric and the validation error metric satisfy the threshold, configuring the neural network in accordance with the parameters;
receiving a plurality of test 3D models of objects with unknown classifications; and
classifying the test 3D models using the configured convolutional neural network.

24. The system of claim 20, wherein the memory further stores instructions that, when executed by the processor, cause the processor to assign the classification to the object in accordance with the plurality of features by:
comparing each of the features to a corresponding previously observed distribution of values of the feature;
assigning the clean classification in response to determining that all of the values of the features are within a typical range; and
assigning a defect classification for each feature of the plurality of features that are in outlier portions of the corresponding previously observed distribution.

25. The system of claim 17, further comprising a display device,
wherein the memory further stores instructions that, when executed by the processor, cause the processor to display the indication of the one or more defects on the display device.

26. The system of claim 25, wherein the memory further stores instructions that, when executed by the processor, cause the processor to:
display, on the display device, the indication of the one or more defects as a heat map overlaid on the 3D multi-view model.

27. The system of claim 17, wherein the memory further stores instructions that, when executed by the processor, cause the processor to control the movement of the object out of a normal processing route based on the indication of the one or more defects.

28. The system of claim 17, further comprising a conveyor system,
wherein the object is moving on the conveyor system, and
wherein the one or more depth cameras are arranged around the conveyor system to image the object as the object moves along the conveyor system.

29. The system of claim 28, wherein the point clouds are captured at different times as the object moves along the conveyor system.

30. The system of claim 17, wherein the 3D multi-view model comprises a 3D mesh model.

31. The system of claim 17, wherein the 3D multi-view model comprises a 3D point cloud.

32. The system of claim 17, wherein the 3D multi-view model comprises a plurality of two-dimensional images.
